(19) United States
(12) Patent Application Publication
(10) Pub. No.: US 2011/0115787 A1
(43) Pub. Date: May 19, 2011

(54) VISULATION OF GEOLOGIC FEATURES USING DATA REPRESENTATIONS THEREOF

(75) Inventor: Benjamin J. Kadlec, Boulder, CO (US)

(73) Assignee: TERRASPARK GEOSCIENCES, LLC, Westminster, CO (US)

(21) Appl. No.: 12/936,532

(22) PCT Filed: Apr. 13, 2009
(86) PCT No.: PCT/US09/40331

§ 371 Date: Jan. 4, 2011

Related U.S. Application Data
(60) Provisional application No. 61/044,150, filed on Apr. 11, 2008.

(51) Int. Cl. G06T 15/00; G06K 9/00; G06F 19/00; G06F 15/00; G01V 1/30

(52) U.S. Cl. 345/419; 382/107; 702/14; 702/19; 702/189

(57) ABSTRACT

One exemplary embodiment presents a unified approach in the form of an Interactive “Violation” (simultaneous visualization and simulation) Environment (IVE) designed to efficiently segment geologic features with high accuracy. The IVE unifies image structure analysis and implicit surface modeling as a surface-driven solution that assists analysts, such as geoscientists, in the segmentation and modeling of faults, channels, and other geobodies in 3-D data, such as 3-D seismic data.

### RELATED APPLICATION DATA

This application claims the benefit of and priority under 35 U.S.C. §119(e) to U.S. Patent Application No. 60/044,150, filed 11 Apr. 2008, entitled “Channel Segmentation,” and is related to PCT Application PCT/US2007/071733 (Published as WO2008/005690), U.S. Provisional Patent Application No. 61/018,958, entitled “Level Set Fault Segmentation,” and U.S. Provisional Patent Application No. 61/018,961, entitled “Structure Tensor Analysis For Seismic Data,” all of which are incorporated herein by reference in their entirety.

### BACKGROUND

In the related application mentioned above, processes are described that assist with the identification of potential hydrocarbon deposits that include performing a structural interpretation of a three-dimensional seismic volume, transforming the three-dimensional seismic volume into a stratal-slice volume, performing a stratigraphic interpretation of the stratal-slice volume which includes the extracting of bounding surfaces and faults and transforming the stratal-slice volume into the spatial domain. As illustrated, an exemplary seismic volume before domain transformation is presented in FIG. 24a of the related application, interpreted horizons and faults used in the transformation are presented in FIG. 24b of the related application and the domain transformed stratal-slice volume is presented in FIG. 24c of the related application. The input seismic volume in FIG. 24a of the related application has deformations associated with syn- and post-depositional faulting. The output domain transformed volume (FIG. 24c of the related application) is substantially free of deformations.

### SUMMARY

Three-dimensional seismic data has been used to explore the Earth's crust for over 30 years, yet the imaging and subsequent identification of geologic features in the data remains a time consuming manual task. Most current approaches fail to realistically model many 3-D geologic features and offer no integrated segmentation capabilities. In the image processing community, image structure analysis techniques have demonstrated encouraging results through filters that enhance feature structure using partial derivative information. These techniques are only beginning to be applied to the field of seismic interpretation and the information they generate remains to be explored for feature segmentation. Dynamic implicit surfaces, implemented with level set methods, have shown great potential in the computational sciences for applications such as modeling, simulation, and segmentation. Level set methods allow implicit handling of complex topologies deformed by operations where large changes can occur without destroying the level set representation. Many real-world objects can be represented as an implicit surface but further interpretation of those surfaces is often severely limited, such as the growth and segmentation of plane-like and high positive curvature features. In addition, the complexity of many evolving surfaces requires visual monitoring and user control in order to achieve preferred results.

Despite volatile economic conditions, long-term trends suggest that worldwide demand for energy will continue to grow in order to support continued world industrialization and improvement of living standards. Because an efficient and cost effective global infrastructure for production and distribution of oil and gas already exists, it is expected to remain a convenient and economical source of energy for the foreseeable future. Extracting oil and gas from the Earth's crust begins with collecting sub-surface data and analyzing it for potential reservoirs and geologic features important to drilling and production. Unfortunately, most of the easy oil fields in the world have already been discovered and therefore current exploration efforts focus on difficult to reach fields or missed plays in already developed fields.

Analyzing the seismic data used to locate reservoirs is a complex task due to the data's unique layered structure, the difficulty in identifying features, and the large size of data sets. In addition, increased acquisition has created an explosion in the amount of seismic data that needs to be analyzed; yet the oil industry is experiencing a drastic shortage of interpreters as the current generation nears retirement. This presents a great opportunity for computer-aided techniques to be developed in order to aid geoscientists in recognizing features in seismic datasets.

A similar problem exists in the medical imaging community for analyzing CT and MRI scans of patients as well as data generated by the visible human project. Research in this area has developed many fundamental techniques in the area of image structure analysis and surface segmentation for 3-D volumetric data. There are many corollaries between the features represented in medical and seismic datasets (e.g. depositional channel features have a similar character to vascular systems), and one can apply the techniques developed herein for medical imaging when considerations such as noise character, local orientations, and the structure of features specific to seismic datasets are taken into account.

Image structure analysis techniques enhance feature structure using partial derivative information. This exemplary approach is powerful because it employs a combination of first and second order derivative information to differentiate between a wide variety of structures. These techniques are only beginning to be applied to the field of seismic interpretation and the information they generate remains to be explored for feature segmentation. This presents an opportunity to adapt image structure analysis in order to create representations for geologic features that can be used to allow for easier segmentation.

Surface segmentation separates features from background data using either an implicit or explicit representation of a surface. Up until recently, most published work in computer graphics and vision for imaging applications have used explicit surfaces constructed from triangles. Triangulated surfaces require extreme care to be taken when discontinuous topological changes occur and smoothness is difficult to guarantee. In addition, there is no guarantee that the result of an explicit surface will be physically realizable. Implicit surfaces are represented volumetrically using level set methods and have an advantage over explicit surfaces in how easily dynamic topological changes and geometric quantities, such as normals and curvatures, are determined. Also, the results of level set simulations are physically realizable implicit surface models, which is desirable when attempting to represent geologic features.

Three-dimensional seismic data interpretation is a challenge in both imaging and segmentation where the ultimate goal is to automatically segment features contained in a data set. Unfortunately, the science of geology has many unknowns and the seismic data used to represent it requires a trained eye and subjective analysis that cannot be reliably automated. Similar problems are manifested in other imaging fields such as when an evolving surface segmentation requires human knowledge to proceed, possibly due to poor imaging or a highly complex feature. In order to account for unknowns in data, visual monitoring and user control of the segmentation that employs domain knowledge is necessary; this is a non-trivial exercise. Therefore, a need and opportunity exists to incorporate image structure analysis and implicit surface modeling into an interactive environment for segmentation. One exemplary embodiment presents a unified approach in the form of an Interactive “Visulation” (simultaneous visualization and simulation) Environment (IVE) designed to efficiently segment geologic features with high accuracy. The IVE unifies image structure analysis and implicit surface modeling as a surface-driven solution that assists geoscientists in the segmentation and modeling of faults, channels, and other geobodies in 3-D seismic data.

An exemplary embodiment of this invention therefore presents a unified approach that combines image structure analysis and implicit surface modeling in an Interactive “Visulation” Environment designed to segment geologic features. The IVE allows geoscientists to observe the evolution of surfaces and steer them toward features of interest using their domain knowledge. In accordance with one exemplary embodiment, the process is implemented on a GPU for increased performance and interaction. The resulting system is a surface-driven solution for the interpretation of 3-D seismic data, in particular for the segmentation and modeling of faults, channels, salt bodies and other geobodies.

It is an aspect of the present invention to provide systems, methods and techniques for data processing.

It is another aspect of this invention to provide systems, methods and techniques for seismic data processing.

It is a further aspect of this invention to provide systems, methods and techniques for 3-D seismic data processing.

Even further aspects of the invention relate to visualizing one or more faults in a data volume.

Even further aspects of the invention relate to visualizing one or more channels in a data volume.

Even further aspects of the invention relate to visualizing one or more salt bodies in a data volume.

Even further aspects of the invention relate to visualizing one or more geobodies in a data volume.

Additional aspects relate to performing structure analysis of an input volume.

Aspects also relate to applying a surface velocity procedure.

Aspects further relate to utilization of a gradient structure tensor to assist with determining an orientation of strata.

Even further aspects relate to using level sets to represent a deformable structure.

Additional aspects relate to usage of velocity of the level set to describe motion of a surface in space and time.

These and other features and advantages of this invention are described in, or are apparent from, the following detailed description of the exemplary embodiments.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The exemplary embodiments of the invention will be described in detail, with reference to the following figures. It should be understood that the drawings are not necessarily shown to scale. In certain instances, details which are not necessary for an understanding of the invention or which render other details difficult to perceive may have been omitted. It should be understood, of course, that the invention is not necessarily limited to the particular embodiments illustrated herein.

FIG. 1 illustrates an exemplary high-level overview of the operation of the interactive visulation environment according to this invention;

FIG. 2 illustrates an exemplary data processing system according to this invention;

FIG. 3 illustrates exemplary seismic strata according to this invention;

FIG. 4 illustrates mean curvature flow shrinking high-curvature regions of an object according to this invention;

FIG. 5 (a-d) illustrates classification of singularities according to this invention;

FIG. 6 illustrates channelness measure in 3-D according to this invention;

FIG. 7 illustrates an exemplary method of identifying the inside of a channel according to this invention;

FIG. 8 illustrates an exemplary more detailed process for the operation of an exemplary embodiment of the invention;

FIG. 8A illustrates an exemplary method of channel detection according to this invention;

FIG. 8B illustrates an exemplary method of salt body detection according to this invention;

FIG. 8C illustrates an exemplary method of geobody detection according to this invention;

FIG. 9 illustrates an exemplary method of structure analysis according to this invention;

FIG. 10 illustrates an exemplary graphical user interface of a screenshot from the IVE;

FIG. 11 illustrates a segmentation of a fault in a 3-D seismic volume;

FIG. 12 illustrates a visual representation of the contribution of level set terms according to this invention;

FIG. 13 illustrates slices of channelness according to this invention;

FIG. 14 illustrates slices of channelness overlaid by a red outline of the level set segmentation according to this invention;

FIG. 15 illustrates a 3-D representation of a segmented channel according to this invention;

FIG. 16 illustrates an original seismic image on a z-slice different from FIG. 15 (top left) and a three-dimensional representation of the segmented channel displayed on the z-slice (top right), x- and on z-slice (bottom left), x- and z-slice rotated (bottom right) according to this invention.

FIG. 17 illustrates two views of the bounding surface of a fault's 2-D manifold, colored surfaces represent the actual 2-D fault manifold and silver surfaces are the bounding surface of the fault according to this invention;

FIG. 18 illustrates threshold-based fault velocity functions for the triangle (left) and the sawtooth (right) form according to this invention;

FIG. 19 an example of high-propagation evolution for (left) initial and (right) final time steps, the background grayscale image is the fault-likelihood data overlaid in red by the level set fault extraction, black arrows point to initial seeds that shrunk and yellow arrow points to a new fault region that the technique discovered according to this invention;

FIG. 20 illustrates a comparison of propagation only flow (left) to propagation flow with curvature flow (right) for the initial seeds (top), blue represents the level set surface and red is the boundary of the surface, bright features in the background image are faults and dark features are non-faults according to this invention;

FIG. 21 (a-h) illustrates medial-surface extraction and segmentation results from two different seismic datasets. The top row shows Seismic-A and bottom row shows Seismic-B as (a,e): original level set simulation output, (b,f): level set distance transform, (c,g): medial surface slices, and (d,h): segmented components according to this invention;

FIG. 22 illustrates tri-linear texture filtering on a seismic volume (top) and a level set volume (bottom). The left image is non-filtered and right image is filtered according to this invention;

FIG. 23 illustrates the determination of the structure tensor on the seismic data around a narrow-band of the level set returns propagation and advection terms on the fly for use in surface evolution according to this invention;

FIG. 24 illustrates automatically extracted seed lineaments for seed points to the level set. Different colored lineaments represent distinct seeds that are approximated to align with faults in the data according to this invention;

FIG. 25 illustrates example of semi-automatic refinement by using the output of an initial level set simulation (left) as the input to a second level set process for the purpose of filling in a gap in the segmentation (right) according to this invention;

FIG. 26 illustrates manual seeding of level sets for planar fault extraction (where white blocks represent manual seeds, green surface is the segmented fault) according to this invention;

FIG. 27 illustrates a time series computed on the GPU (left to right, top to bottom) showing a fault surface evolving from a seed point in a seismic dataset according to this invention;

FIG. 28 (a-c) illustrates segmentation of a high-amplitude geobody in a 3-D seismic volume showing (a) user defined seed point to start evolution. (b) and (c) show the extracted isosurface of the level set while it evolves at 50 and 200 iterations, respectively according to this invention;

FIG. 29 illustrates a time series computed on the GPU (left to right, top to bottom) showing a channel surface evolving from a line of seed points according to this invention;

FIG. 30 illustrates computational steering by interactively adding growth regions to the surface according to this invention;

FIG. 31 illustrates computational steering by interactively removing growth regions of the surface according to this invention;

FIG. 32 illustrates from left to right, adding blue seed points to the edge of a surface then evolving it for 30 iterations. The result is an extended version of the implicit surface according to this invention;

FIG. 33 illustrates evolution of fault based on a manual seed, followed by merging and surface creation according to this invention;

FIG. 33 illustrates an example of how a fault feature can be imaged in seismic data according to this invention;

FIG. 34 illustrates the exemplary imaging of a fault according to this invention;

FIG. 35 illustrates an exemplary geobody having connected voxels according to this invention;

FIG. 36 illustrates an exemplary segmentation of a channel according to this invention;

FIG. 37 illustrates an example of segmentation of a high-amplitude geobody according to this invention;

FIG. 38 illustrates an example of smart merging according to this invention;

FIG. 39 illustrates an example of hide merging according to this invention; and

FIG. 40 shows the relationship between smart and hide merging according to this invention.

### DETAILED DESCRIPTION

The exemplary embodiments of this invention will be described in relation to processing, interpretation, visualization and simulation of data, and in particular seismic data. However, it should be appreciated, that in general, the systems and methods of this invention will work equally well for any type of data representing any environment, object, body or article.

The exemplary systems and methods of this invention will also be described in relation to seismic data interpretation and manipulation. However, to avoid unnecessarily obscuring the present invention, the following description omits well-known structures and devices that may be shown in block diagram form or otherwise summarized.

For purposes of explanation, numerous details are set forth in order to provide a thorough understanding of the present invention. However, it should be appreciated that the present invention may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices or collocated on a particular node of a distributed network, such as a communications network. As will be appreciated from the following description, and for reasons of computational efficiency, the components of the system can be arranged at any location within a distributed network without affecting the operation of the system.

Furthermore, it should be appreciated that various links can be used to connect the elements and can be wired or wireless links, or any combination thereof, or any other known or later developed element(s) that is capable of supplying and/or communicating data to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique, including those performed by a system, such as a processor, an expert system or neural network.

Additionally, all references identified herein are incorporated herein by reference in their entirely.

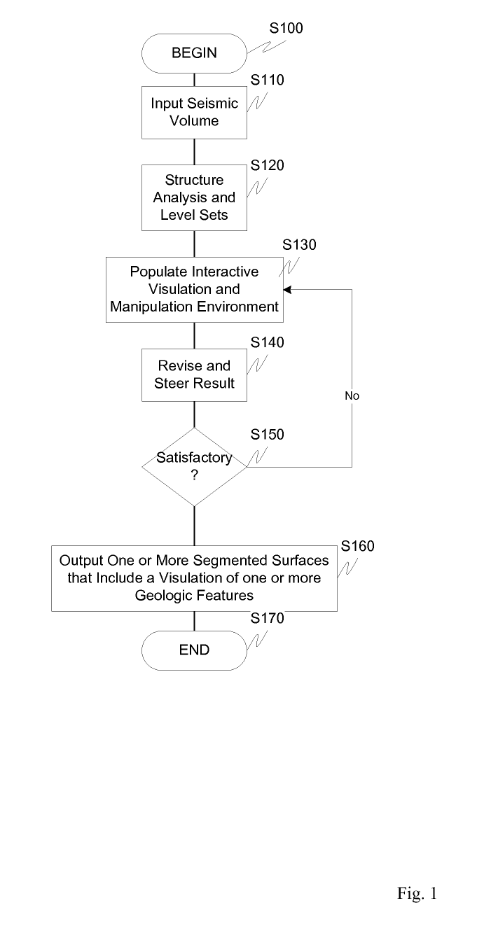

FIG. 1 outlines a high level overview of an exemplary visulation according to this invention. In particular, control begins in step S100. Next, in step S110, a seismic volume (or other data volume such as medical information) is input. Then, in step S120 structure analysis and level set analysis is performed. Control then continues to step S130.

In step S130, the interactive visulation and manipulation environment is populated and displayed to a user. Next, in step S140 the “result” is steered and manipulated until a satisfactory representation is developed. In step S140, the level sets continue to be used to revise and steer result. The revising and steering of the result uses the level set technique that was initialized in step S120. Then, in step S150 control continues to step S160. Otherwise, control jumps back to step S130 for further revising and adjustment of one or more parameters.

In step S160, one or more segmented surfaces that include a visulation of one or more features, such as geologic features, are saved and or output.

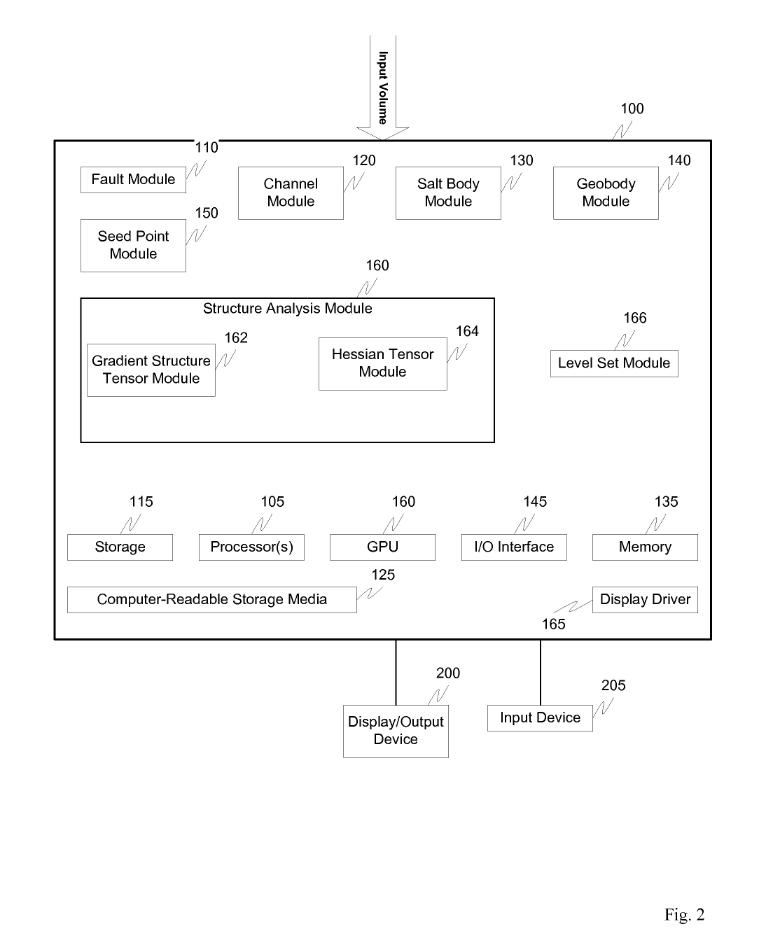

FIG. 2 illustrates an exemplary data processing system 100. The data processing system 100 comprises a fault module 110, a channel module 120, a salt body module 130, a geobody module 140, a seed point module 150, a structure analysis module 160, a level set module 166, a processor 105, storage 115, one or more computer-readable storage media (on which software embodying the techniques disclosed herein can be stored and executed with the cooperation of a controller, memory 135, I/O interface 145 and storage 155) 125, a GPU 160 (Graphics Processing Unit), memory 135, display driver 165 and an I/O interface 145, all connected by link(s) (not shown). The system can further be associated with an output device, such as computer display(s) 200, on which the outputs of the various techniques can be shown to a user and an input device 205, such as a keyboard and/or mouse.

The Structure analysis module further includes a gradient structure tensor module 162 and a Hessian tensor module 164.

The operation of the above elements will now be discussed in relation to the corresponding overall theory behind an exemplary embodiment of this invention. Structure analysis of a 3-D dataset (input volume) finds it roots in the field of image processing where the structure of a 2-D image is represented as gradients, edges, or similar types of information. This translates to 3-D data where gradients, edges, curvature, and other image elements can be represented in three-dimensions. This information is gained by calculating derivatives and partial derivatives, and then analyzing the vector representation of magnitude changes of pixel (or voxel in 3-D) values. In two-dimensions the orientation of maximum change in an image corresponds to Equation 1, where Iₓ is the partial derivative of image I in the x-direction, and I_{y} is the partial derivative in the y-direction.

$$\begin{matrix}\vert g \vert = \sqrt{{I}_{x}^{2} + {I}_{y}^{2}} \\ θ = {tan}^{- 1} ( \frac{{I}_{y}}{{I}_{x}} ) & Equation 1 \\ {I}_{x} = \frac{\partial I}{\partial x} \\ {I}_{y} = \frac{\partial I}{\partial y} & Equation 2\end{matrix}$$

The vector resulting from this is directed according to the ordering of pixel points (high to low, or low to high values) and points along the orientation of the angle θ, which varies from [0,π) with a magnitude given by g. Another helpful way to consider this vector is to think of it as the normal vector to a gradient contour in the image, which will make more sense when working with level sets hereinafter. The calculation of the Iₓ, I_{y} partial derivatives (Equation 2) can be accomplished using standard central differences between neighboring pixels (voxels) or more robustly by convolving neighboring voxels with a Gaussian mask over a range of voxels and then taking the difference of the Gaussian-smoothed neighbors.

The orientation of seismic strata are generally not horizontal (parallel to the ground plane), which means filtering techniques used on seismic images must take into account local orientations, otherwise undesired blurring across horizons will inevitably result as in the case of mean and median filtering. To measure the orientation of seismic strata, the gradient structure tensor (GST) is used. For a local neighborhood I(x,y,z) in a 3-D image the GST is given by Equation 3.

$$GST = [ \begin{matrix}{I}_{x}^{2} & {I}_{x} {I}_{y} & {I}_{x} {I}_{z} \\ {I}_{x} {I}_{y} & {I}_{y}^{2} & {I}_{y} {I}_{z} \\ {I}_{x} {I}_{z} & {I}_{y} {I}_{z} & {I}_{z}^{2}\end{matrix} ] \qquad Eqaution 3$$

Since the GST represents an orientation rather than a direction, this formulation allows the blurring of tensors in a way that lets vectors pointing in opposite directions to support an orientation rather than counteract each other. In addition, the GST is a 3×3 positive semidefinite matrix, which is invariant to Gaussian convolution.

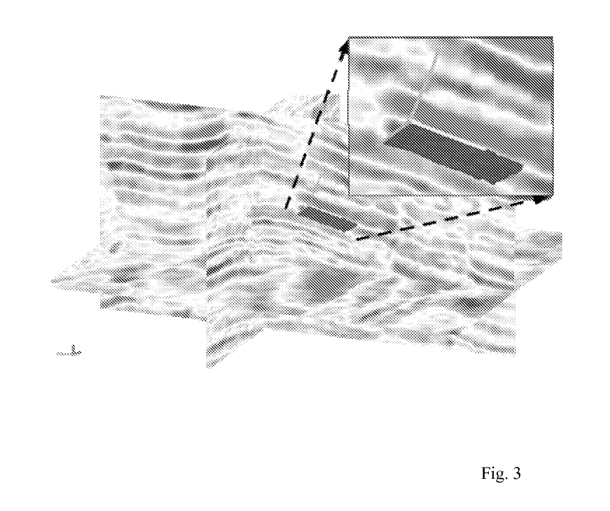

Using Gaussian convolution to average the tensors creates a more robust representation of the orientation field. The eigenanalysis of the GST provides information about the local orientation and coherence of the seismic data. Eigenvectors define a local coordinate axis while eigenvalues describe the local coherence, which represents the strength of the gradient along the respective eigenvectors. The dominant eigenvector represents the direction of the gradient orthogonal to the seismic strata, while the smaller two eigenvectors form an orthogonal plane parallel to the seismic strata. Near faults or other discontinuities in the data, the strength of the dominant eigenvector before Gaussian smoothing is not sufficient to confidently define a plane orthogonal to the strata (See FIG. 3—The seismic strata (red-to-blue layering) are rarely perfectly horizontal. Green surface describes the correct local coordinate system for small section of the volume). However, after Gaussian smoothing of the tensors, a more confident eigenstructure is represented at faults and discontinuities that more accurately represent the true orientation. The orientation of the respective eigenvectors provides a robust estimate of the local orientation at each point in the image. This orientation may be described by two angles, the dip angle θ and the azimuth angle θ using the three components of the eigenvector (eₓ, e_{y}, e_{z}) as defined by

$$cos φ = \frac{{e}_{x}}{\sqrt{{e}_{x}^{2} + {e}_{y}^{2}}} \\ sin φ = \frac{{e}_{y}}{\sqrt{{e}_{x}^{2} + {e}_{y}^{2}}} \\ cos θ = \frac{{e}_{z}}{\sqrt{{e}_{x}^{2} + {e}_{y}^{2} + {e}_{z}^{2}}} \qquad Equation 4$$

where 0°<φ<360° and 0°<θ<180°.

The Hessian is determined as the matrix of the second-order partial derivatives of the image (or volume). The Hessian tensor is given by

$$H = [ \begin{matrix}{I}_{xx} & {I}_{xy} & {I}_{xz} \\ {I}_{xy} & {I}_{yy} & {I}_{yz} \\ {I}_{xz} & {I}_{yz} & {I}_{zz}\end{matrix} ] \qquad Equation 5$$

where second partial derivatives of the image I(x,y,z) are represented as Iₓₓ, I_{yy}, I_{zz}, and so forth. The eigenvalues of this tensor are ordered as λ₁>λ₂>λ₃ and their corresponding eigenvectors as v₁, v₂, v₃, respectively. Using the eigenvalues, this tensor can classify local second-order structures that are plane-like, line-like, and blob-like. The conditions for which the different eigenvalues describe these features as:
Blob-like: λ₁≈λ₂≈λ₃
Plane-like: λ₁>>λ₂≈λ₃
Line-like: λ₁≈λ₂>>λ₃
   By employing second-order information in the dataset, it may not be possible to calculate curvature, corners, flatness, and other 2^{nd} order information. This analysis will be used for imaging confidence and curvature features described hereinafter and further applied using similar analysis for the use of locating critical points for medial surface extraction.

Level sets are an implicit representation of a deformable surface. One advantage of level set methods is that instead of manipulating a surface directly, it is embedded as the zero level set of a higher dimensional function called the level set function. The level set function is then evolved such that at any time the evolving surface can be implicitly obtained by extracting the zero level set.

An implicit representation of a surface consists of all points S={i|φ(i)=0}, where φ: R³ [symbol] R. Level sets relate the motion of the surface S to a PDE on the volume as

$$\frac{\partial φ}{\partial t} = - \vec{V} \cdot ∇ φ \qquad Equation 6$$

where V describes the motion of the surface in space and time. This framework allows for a wide variety of deformations to be implemented by defining an appropriate V. This velocity (or speed) term can be combined with several other terms such as geometric terms (e.g. mean-curvature) and image-dependent terms. Equation 4 is sometimes referred to as the level set equation.

The initial level set must be represented as a signed distance function where each level set is given by its distance from the zero level set. The distance function is signed so there is differentiation between the inside and outside of the level set surface. For this work all points contained within the level set surface are considered to be negative distances. The distance function is computed using a technique that solves the Eikonal equation, which is commonly done using the fast marching method or the fast sweeping method. This equates to a surface expanding in the normal direction with unit speed and can be considered a special case of the level set function.

The surface integral (surface area) and the volume integral of the surface S can be easily defined using the implicit representation of the level set. The Dirac delta function on the interface is defined as

δ(i)|∇φ| Equation 7

and the Heaviside function (integral of the Dirac delta function) as

$$H ( i ) = \{ \begin{matrix}1 & if φ ( i ) \geq 0 \\ 0 & if φ ( i ) < 0\end{matrix} \qquad Equation 8$$

Using these functions one can derive the surface area integral (in 3-D)

$${\int }_{S}^{ } δ ( i ) \vert ∇ φ \vert d i \qquad Equation 9$$

and the volume integral

$${\int }_{S} H ( - i ) d i \qquad Equation 10$$

Additional intrinsic geometric properties of the implicit surface can be easily determined using this formulation. For instance, the normal is computed on the level set as

$$\vec{n} = \frac{∇ φ}{\vert ∇ φ \vert} \qquad Equation 11$$

and the curvature is obtained as the divergence of the normal as

$$κ = ∇ \cdot \frac{∇ φ}{\vert ∇ φ \vert} \qquad Equation 12$$

The level set equation (Equation 6) contains a velocity term V. The velocity of the level set is a representation that describes the motion of the surface in space and time. This framework allows for a wide variety of deformations to be implemented by a combination of global, geometric, and image-dependent terms, depending on the application area. Equation 13 gives a basic template of a velocity equation as the combination of two data-dependent terms and a surface topology term. The D term is a propagating advection term scaled according to α in the direction of the surface normal. The term ∇·(∇φ/|∇φ|) is the mean-curvature of the surface defined in Equation 12 and its influence is scaled by β. The final term ∇A·|∇φ| is the dot product of the gradient vector of an advection field with the surface normal, which is scaled by γ.

$$\frac{\partial φ}{\partial t} = \vert ∇ φ \vert [ α D ( I ) + β ( ∇ \cdot \frac{∇ φ}{\vert ∇ φ \vert} ) ] + γ ( ∇ A ( I ) \cdot \vert ∇ φ \vert ) \qquad Equation 13$$

Velocity functions are considered that contain terms of advection and diffusion. It is important to understand the difference between these flows in the level set context. This can be stated that advective flow is a propagation of finite speed in a certain direction, while diffusive flow is defined everywhere in all directions. The numerical analysis of these terms relates to solving a hyperbolic PDE for advection that is solved using an upwind scheme and a parabolic PDE for diffusion that is solved by central differences. In this scheme, stability can be enforced by using the Courant-Friedrichs-Lewy (CFL) condition, which states that numerical waves should propagate at least as fast as physical waves. Therefore, the time step used for iterating the level set must be less than the grid spacing divided by the fastest velocity term in the domain. The time step is restricted based on the velocity term as shown in Equation 14 where v(i) is the velocity calculated at voxel i and Δx, Δy, and Δz are the grid spacing in three-dimensions.

$$∇ T \leq ∀ i ( \frac{max ( Δ x , Δ y , Δ z )}{max ( v ( i ) )} ) \qquad Equation 14$$

With a velocity function consisting of advective and diffusive terms, image-based scaling factors can be used to guide the terms, such as ones derived from volume attributes. Hereinafter, a unique set of velocity functions is developed for evolving surfaces to segment geologic features in seismic data.

Level set motion by mean curvature is considered such that the interface moves in the normal direction with a velocity proportional to its curvature v=−bκ where b>0 is a constant and κ is the mean curvature defined in Equation 15.

$$κ = ∇ \cdot \frac{∇ φ}{\vert ∇ φ \vert} \qquad Equation 15$$

For b>0 the front moves in the direction of concavity, such that circles (in 2-D) or spheres (in 3-D) shrink to a single point and disappear (see FIG. 4 where mean curvature flow shrinks high-curvature regions of an object to a single point (left to right, top to bottom). Oscillations on the moving front decay for this case since the total variation of the speed function for b positive has derivative v=−b and hence the total variation decays.

Returning to further functionality of the structure analysis module, after removing noise in seismic data by conducting anisotropic smoothing along stratigraphic layers, the result is a new seismic volume with attenuated noise and enhanced features. The next step is to use structure analysis for extracting information that helps identify data features. First, a more robust representation of the orientation field given by the structure tensor is computed using Gaussian convolution, which averages the tensor orientations. Next, the eigenanalysis of the smoothed structure tensor can be computed in order to provide the local orientations as well as indications of singularities in the data volume. Thanks to the representation of the GST, three real eigenvalues and eigenvectors will be found. The eigenvectors define a local coordinate axis while eigenvalues describe the local coherence, which represents the strength of the gradient along each respective eigenvector. Potential critical points are located in the data volume by using the three-dimensional gradient magnitude given by Equation 16.

|∇I|=\sqrt{Iₓ²+I_{y}²+I_{z}²} Equation 16

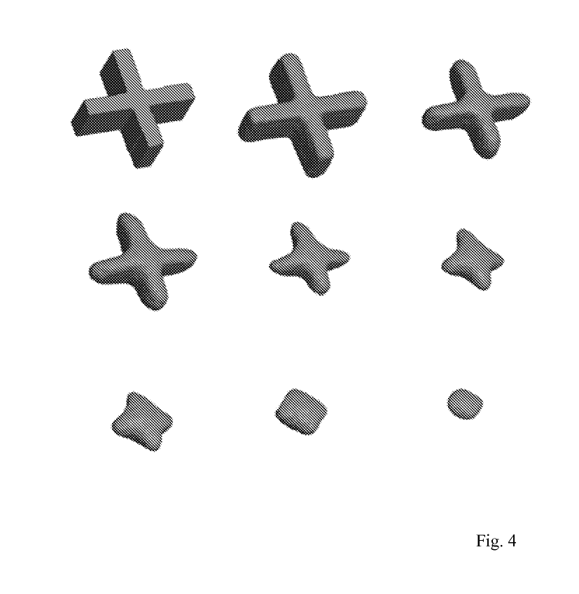

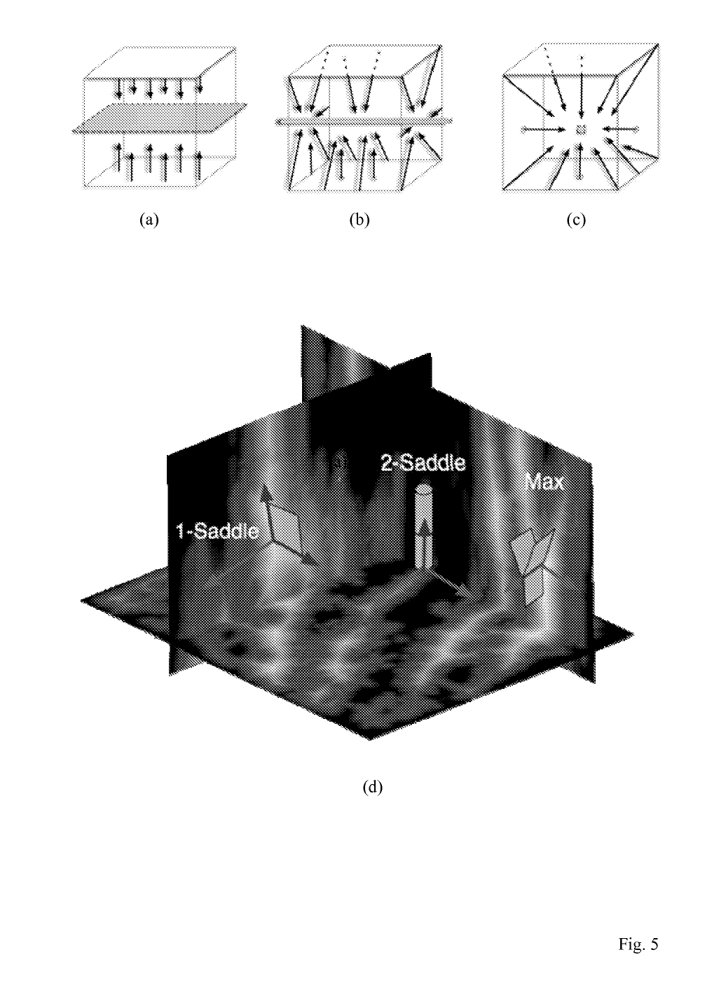

The gradient magnitude is a simple and powerful technique for detecting singularities. When isolating medial-surfaces in a distance transform volume, singularities are defined by areas of low gradient magnitude. The opposite is used when identifying channel edges from a seismic volume. After being isolated, singularities can be classified as 1-saddles, 2-saddles, and maximums as depicted in FIG. 5. In FIG. 5, (a): 1-Saddle, (b): 2-Saddle, and (c) Maximum critical points of a surface in 3D. FIG. 5 (d) gives examples of each critical point type in a seismic fault dataset. These three types of singularities (or critical points) are classified by their eigenstructure as:
1. 1-Saddle: λ₁>>λ₂≈λ₃
2. 2-Saddle: λ₁≈λ₂>>λ₃
3. Maximum: λ₁≈λ₂≈λ₃
   where λ₁, λ₂, λ₃ are the three eigenvalues of the structure tensor in descending order. In the context of classifying medial-surface components, the dominant eigenvector of a 1-saddle represents the orientation of the gradient orthogonal to the surface, while the smaller two eigenvectors form an orthogonal plane parallel to the surface. For a 2-saddle, the two most dominant eigenvectors represent the gradient orientation of the surface and the smallest eigenvector represents the orientation parallel to the surface. A maximum critical point is characterized by an incoherent or chaotic eigenstructure with no dominant orientation. These three structures can properly identify all critical points from a 3-D object, and will find further use in identifying and classifying medial surfaces of level sets.

A structure analysis technique to specifically enhance geologic channels in seismic data is described hereinafter. Previous sections have described more general approaches to enhancing and locating features using the first-order structure tensor. Now, a mathematical model given by the second order tensor (Equation 5), called the Hessian matrix, is used to enhance translation invariant second order structures in a seismic dataset. The type of seismic data used in this section is one that has been smoothed to enhance continuous stratigraphy more than small discontinuities.

In similar work, Frangi et al. exploited the eigenvalues of the Hessian in order to develop a MRI vessel enhancement filter. This resulted in a vesselness function that integrated all three eigenvalues computed at a range of scales in order to detect various sizes of vessels. Sato et al. expanded on this work and used the Hessian to detect sheets and blobs in 3-D images. Seismic channels represent a domain-specific image feature that cannot be appropriately modeled using either of these existing techniques of Hessian analysis, due to a channel's unique layered structure. For that reason a new confidence and curvature-based attribute has been created that is able to enhance channel features and provide the terms for a PDE used in segmentation.

Bakker et al. detected channels in 3-D seismic datasets by using the first order structure tensor (GST) to identify the location of features while honoring seismic orientation. In particular, they used an orientated GST and enhanced features while removing noise by filtered eigenanalysis. Through their orientated representation, they were able create a curvature-corrected structure tensor that accounted for line-like and plane-like curvilinear structures. They attain a confidence measure from the eigenvalues of the transformed GST, where larger eigenvalues provide stronger confidence in the orientation estimation. Their unique approach to extracting curvature information uses a parabolic transformation of the GST, which yields a curvature-corrected confidence measure that is maximized for the transformation most closely resembling local structure.

The exemplary method presented herein is similar to that of Bakker et al. in how confidence and curvature information is obtained from image structure analysis. Although, there is a significant difference in the approach presented here since it uses the second order tensor to directly extract confidence and curvature information with no intermediate transformation. The second order tensor has the advantage of directly providing this information without needing to use a parabolic transformation. Concerns are often made about error in second order calculations that can result in unstable tensor fields. This problem is largely overcome by applying tensor smoothing across the volume using a Gaussian kernel, which stabilizes the tensor components without destroying the Hessian representation. The confidence and curvature information is later used to drive a segmentation process for completely extracting channel features, which is something that was not considered in previous work.

A measure of confidence and curvature in seismic data will correspond to regions of high depositional curvature that present a strong and confident amplitude response. As described, it can be seen that this description maps well to the imaging of stratigraphic features such as channels. One exemplary goal is to define a channelness measure that captures the specific structure associated with channels. The first eigenvector v₁ and its corresponding eigenvalue λ₁ are a primary focus. Due to the layered structure of channels, they are approximated as planar features with high curvature along the gradient direction (FIG. 5 (a)), which corresponds to the first eigenvector. Therefore, by comparing the first eigenvector to the second, a channelness measure is defined in Equation 17 as the difference of the first eigenvalue λ₁ with the second λ₂ scaled by the mean average of all λⁱ₁:

$$C ( I ( x , y , z ) ) = \frac{n}{{\sum }_{i ∈ I} {λ}_{1}^{i}} \frac{( {λ}_{1} - {λ}_{2} )}{( {λ}_{1} + {λ}_{2} )} \qquad Equation 17$$

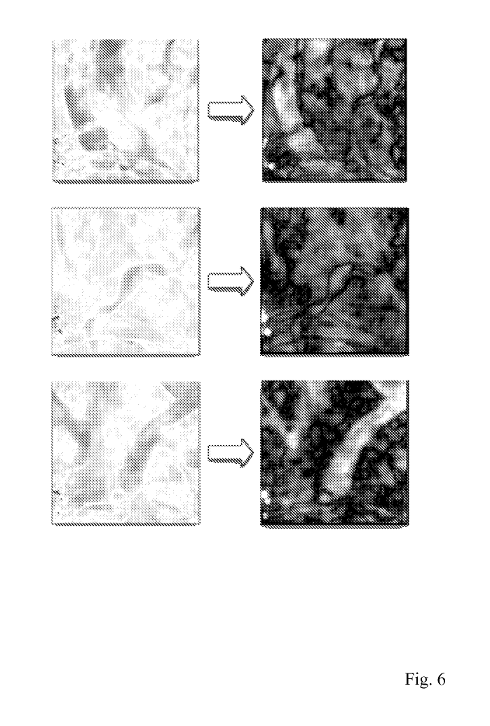

Since channels generally have a relatively constant cross section, the second order tensor is smoothed with a single Gaussian sigma value. Choosing a sigma value that approximates the distance across a channel results in optimal enhancement. FIG. 6 shows stratal slices displaying the channelness attribute on three different data sets. More specifically, in FIG. 6, the channelness measure calculated in 3-D on the stratal slice shown on the left, with the resulting attribute on the right where bright values correspond to a high likelihood of a channel. Channel edges can be found by computing the gradient of the attribute. As described hereinafter, a unique form of the level set equation driven by this channelness measure specifically for segmenting channel features using second order tensors derived from seismic images is presented.

Enhancing fault features directly from the seismic volume using the first-order structure tensor is described hereinafter. There is a long established line of research in seismic interpretation that has lead to the characterization of geologic faults based on their structural character: faults are discontinuities in the strata that extend vertically. This characterization is the focus in developing a function that returns positive propagation values for features and negative propagation values for non-features.

Typically, faults are enhanced from raw seismic datasets using a 3-step approach: vertical discontinuities are detected, vertical discontinuities are enhanced laterally in 2-D, and then they are enhanced again laterally and vertically in 3-D. While this is an over-simplification of the fault enhancement technique, it should still be obvious that faults are never enhanced directly from a seismic volume. Instead, a number of cascaded techniques are used to create a final volume that measures fault likelihood. An effective implementation of this technique provided by TerraSpark Geosciences (B. J. Kadlec, H. M. Tufo, Medial Surface Guided Level Sets for Shape Exaggeration, IASTED Visualization, Imaging, and Image Processing (VIIP), Special Session on Applications of Partial Differential Equations in Geometric Design and Imaging, September 2008) generates a measure of Fault Enhancement, which is essentially a probability that represents the likelihood for a fault to exist at a given voxel in the volume. The problem with using a number of cascaded attribute volumes to enhance fault structure is that incorrect information can be added anywhere along the pipeline and it is difficult to reference the source of this misinformation. Although these cascaded techniques are computationally efficient and produce reliable and quality representations of fault features, it is still beneficial to generalize the approach to a single function that can be computed directly from the seismic data.

$$var ( x , y , z ) = plane ( {\overline{v}}_{2} \times {\overline{v}}_{3} ) \\ f ( x , y , z ) = {\sum }_{i = - n}^{n} var ( x + i {\overline{v}}_{1}^{x} , y + i {\overline{v}}_{1}^{y} , z + i {\overline{v}}_{1}^{z} ) \qquad Equation 18$$

Therefore, it is desired to directly enhance faults from the seismic data using a single function. This can be accomplished by looking for discontinuous features in the seismic strata by calculating the variance across the strata. In particular, discontinuities can be located along the seismic strata defined by the two smaller eigenvectors of the structure tensor. Given this representation, the first step is to compute the variance within a user-defined planar window along the strata of the voxel under consideration. Next, moving along the positive and negative direction of the dominant eigenvector and using the same planar window, additional variances are calculated and summed together. The summation of these variances completes the fault attribute computation. Other fault imaging techniques like coherence, semblance, or continuity follow a similar approach and achieve comparable results in recognizing these discontinuous regions. Part of what makes this approach unique is that the local strata is used to guide the vertical summation of variances, which is different from traditional approaches that make an assumption of perfectly horizontal strata layering.

Function ƒ(x,y,z) in Equation 18 results in a scalar value such that higher values correspond to a greater likelihood of a fault and a lower value corresponds to a low likelihood of a fault. It will be shown that this analysis of discontinuities in seismic data can be used to directly guide level sets for fault extraction. As discussed hereinafter, a technique is described for the enhancement of fault features calculated on the fly directly in seismic data during level set surface evolution.

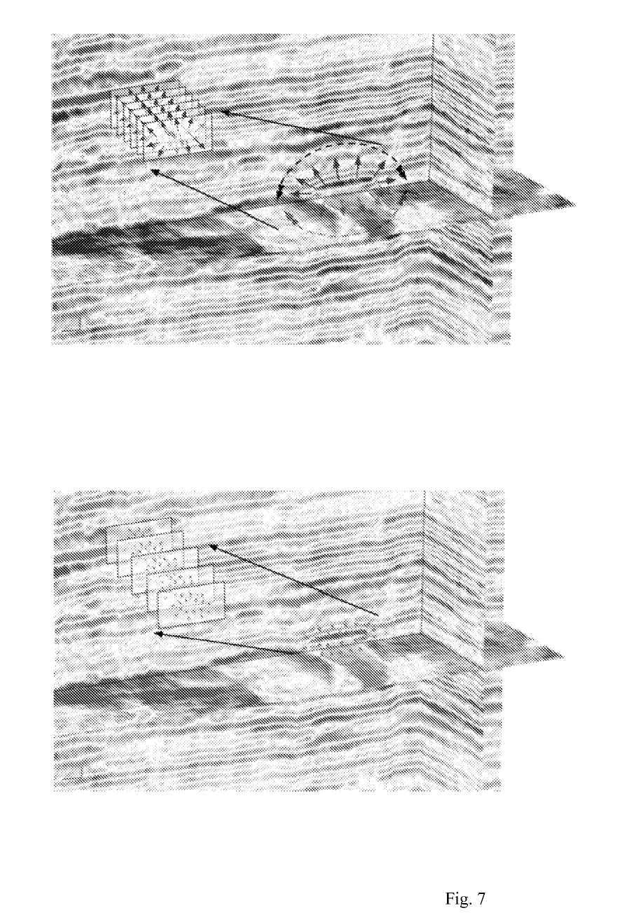

A new technique for segmenting channel features from 3-D seismic volumes is discussed in relation to and supplemental to previous teachings as well as FIG. 7. The strength and direction of second-order eigenvectors are used to enhance channel features by generating a confidence and curvature attribute. Now, that tensor-derived attribute is used to form the terms of a PDE that is iteratively updated using the level set method. Results from this technique are shown on two seismic volumes in order to demonstrate the effectiveness of the approach. In FIG. 7, computation of the inside of a channel by identifying high curvature on lateral slices is shown on the left, and the location of channel edges based on the gradient on the boundary of a channel is shown on the right.

The confidence and curvature analysis of the Hessian allows for the volumetric enhancement of features, but it does not complete the segmentation required to fully represent a channel. Recall that 3-D image segmentation can be accomplished explicitly in the form of a parameterized surface or implicitly in the form of a level set. As described, the level set is the preferential technique because of its ability to handle complex geometries and topological changes, among other reasons. The level set method requires additional information about regions to be segmented in order to drive the propagation of the implicit surface. This is commonly done in the form of a scalar speed function that defines propagation speeds in the surface normal direction. Feddern et al. recently described a structure tensor valued extension of curvature flow for level sets. Their work generalized the use of the structure tensor for mean curvature flow by utilizing image tensor components in the curvature calculation. One exemplary embodiment expands on the generalization of Feddern et al. by allowing a level set surface to evolve towards specific features using a propagation speed given by a tensor-derived channelness term, an advection motion also based on the channelness term, and mean-curvature motion to encourage a smooth final segmentation.

In order to guide the level set evolution towards channel features, the velocity equation comprises two data-dependent terms and the mean-curvature term. The level set evolution is therefore defined as the combination of three terms as shown in Equation 19:

$$\frac{\partial φ}{\partial t} = \vert ∇ φ \vert [ α D ( I ) + β ( ∇ \cdot \frac{∇ φ}{\vert ∇ φ \vert} ) ] + γ ( ∇ A ( I ) \cdot \vert ∇ φ \vert ) \qquad Equation 19$$

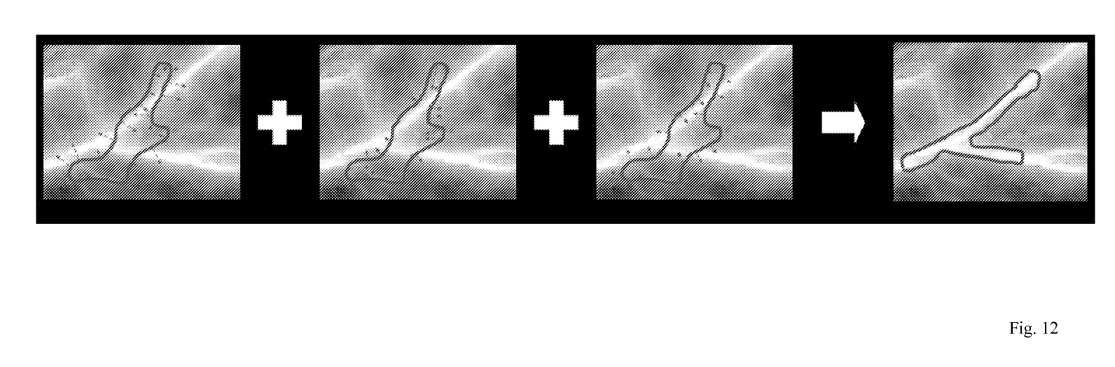

The D term is a propagating speed term defined by the channelness (equation 14) and scaled according to α in the direction of the surface normal. The term ∇·(∇φ/|∇φ|) is the mean-curvature of the surface and its influence is scaled by)β. The final term ∇A·|∇φ| is the dot product of the gradient vector of the advecting force, defined as inverse channelness, with the surface normal. The advecting inverse channelness gradient is scaled by γ. The contribution of each of these terms is generalized in FIG. 12 for a simple 2-D segmentation example of evolving a shape towards a bright feature. FIG. 12, represents a visual representation of the contribution of level set terms in Equation 19 for evolving a surface (or contour) towards a bright intensity feature (from left to right) in 2-D.

The combination of two image-fitting functions with a mean-curvature term is necessary to achieve realistic channel segmentation. The propagating channelness term is derived from the second order structure tensor and drives the segmentation into regions with a high likelihood of containing a channel feature. This representation is appealing as the physical process being calculated in this term can be interpreted as an external convection field. Although far from realistically simulating the ancient fluid flow that created the channel, the channelness guided propagation follows convective laws used in the erosion and deposition of a flowing medium and therefore has physical meaning. As channelness highlights the interior of a channel, the gradient of its inverse highlights feature boundaries and edges. Using this gradient as an advecting force represents the way in which the evolving surface moves towards channel edges when parallel to them, but does not cross over the edge. When driven by the channelness propagation, this advecting force acts like the bank of an ancient channel where flowing medium is forced to stop and move parallel along the edge. The mean-curvature of the surface is useful for alleviating the effects of noise in the image by preventing the surface from leaking into non-channel regions and maintaining a smooth representation. The combined contribution of these terms can be adjusted using the α, β, and α constants according to the nature of the feature being segmented. In general, an equal contribution value of ⅓ for each term is sufficient to accurately segment the channel. In the case of a greatly meandering channel, the mean-curvature term (γ) should be de-emphasized in order to allow a more sinuous segmentation.

The results of segmentation using confidence and curvature-guided level sets are shown for channels from two different 3-D seismic volumes. In practice, geoscientists prefer to manually define the centerline of a channel they hope to segment since it is a relatively quick step compared to manually interpreting the entire 3-D channel surface, which requires exponentially more time. For this reason, the initial seed used in each of the segmentations was a 1-pixel wide tube manually drawn to approximate the center of the channel from end to end. Level set seeding is discussed in further detail hereinafter.

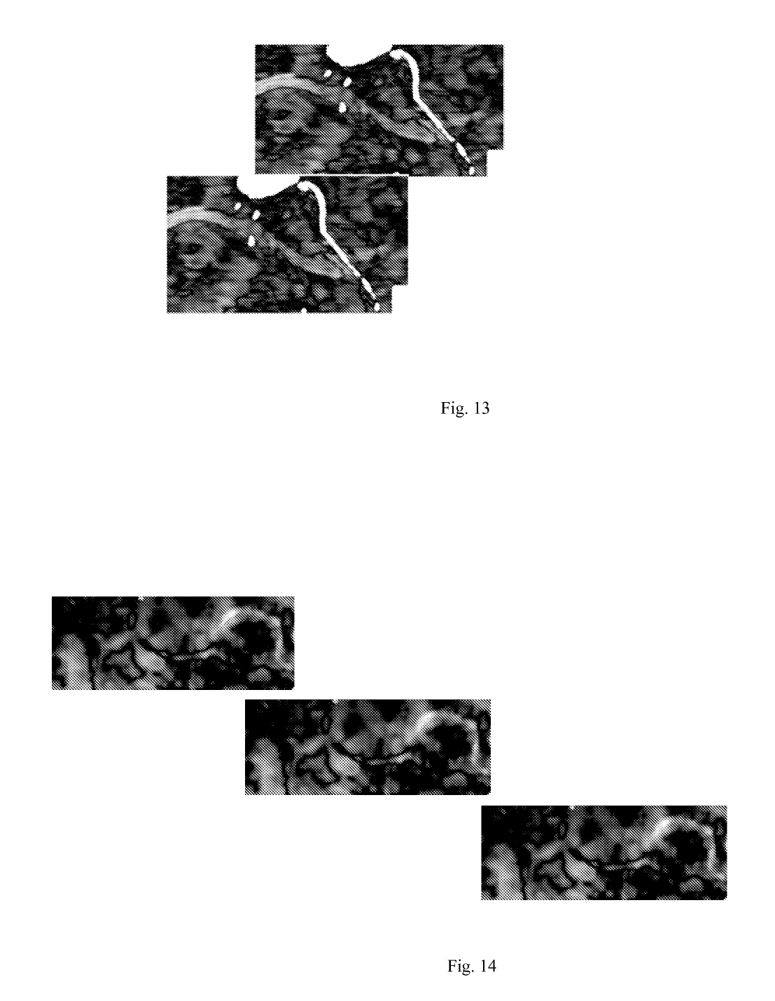

The channel in FIG. 13 is cut by discontinuities (faults), which can be seen on the time slice view as bright isotropic regions. The image was first anisotropically diffused along the seismic strata, which improved imaging near the discontinuities to create a more continuous image of the channel. Next, the image was segmented using the approach presented in this section. That resulted in the 3-D representation of the channel shown in FIG. 13. It should be noted that this surface is the result of applying the method with a Gaussian sigma of 5.0 for smoothing the structure tensors and equal scaling values used for α, β, and γ of the level set evolution equation. In FIG. 13, a slice of channelness attribute of 3-D seismic volume overlaid by the red outline of the level set segmentation is illustrated with from left to right, increasing iterations of 10, 50 and 100 respectively.

The channel shown in FIG. 14 is a narrow meandering channel. Enhancing this channel requires a smaller Gaussian sigma of 2.0 and a β value approximately half the size of α and γ. As mentioned above, the β value for the mean-curvature should be adjusted with respect to the α and γ values depending on the channel that is being segmented. Since this channel is more sinuous, decreasing the influence of the mean-curvature term allows it to be treated as such. In FIG. 14, a slice of channelness attribute of meandering channel from 3-D seismic volume, overlaid by the red outline of the level set segmentation is shown with left to right, increasing iterations of 10, 50 and 100 respectively.

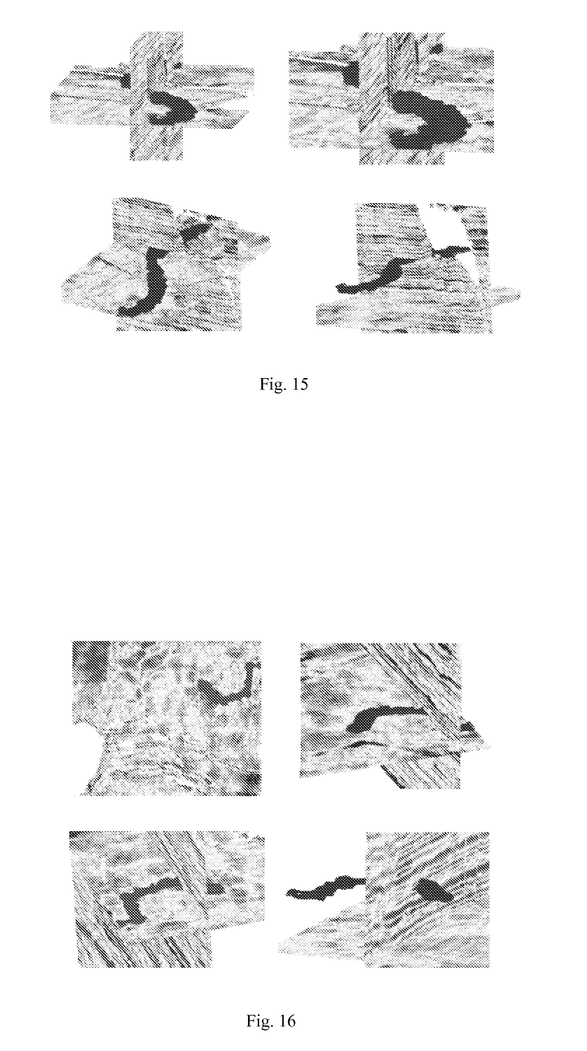

In FIG. 15, a three-dimensional representation of a segmented channel displayed in different orientations is shown on a y,z-slice (top left), y- and z-slice (top right), x- and z-slice (bottom left), x- and z-slice rotated (bottom right).

FIG. 16 shows a different slice of the original 3-D volume, and the 3-D segmentation of the meandering channel at different rotations.

In general, for this application, it is not desired to have a single parameter-set used for all channels, since over geologic time channels often deposit on top of one another. When this happens it becomes necessary to differentiate between two intersecting features by manually choosing these parameters. For this reason, the technique was developed such that a limited amount of user-control is necessary in order to allow semi-automated segmentation of channels.

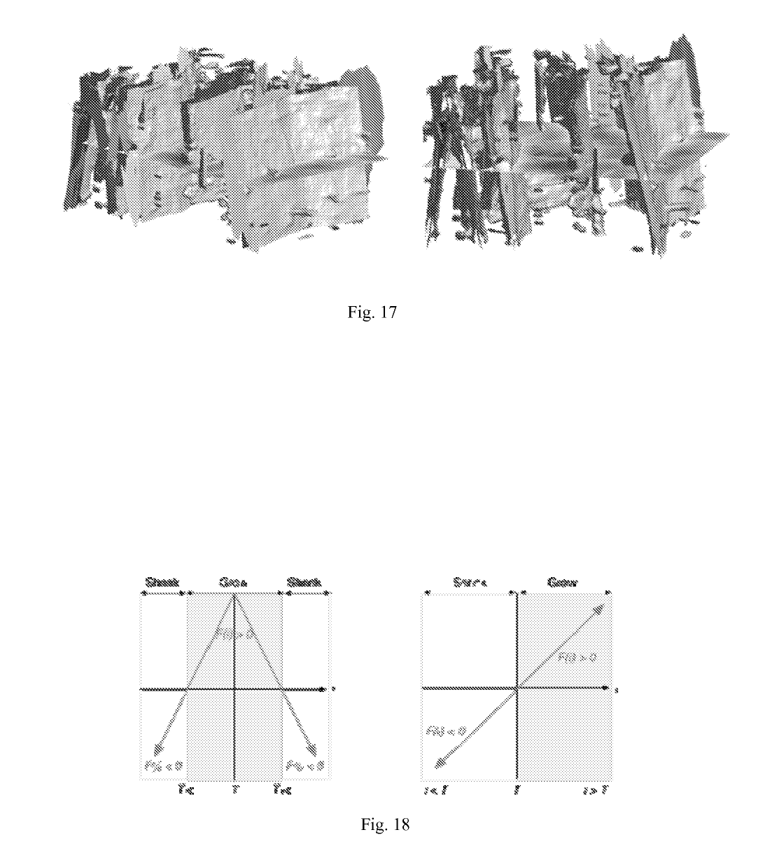

This section focuses on representing planar level sets in 3-D for the purposes of fault segmentation. This is challenging for implicit surface modeling since a planar fault surface is a 2-D manifold in three-dimensions, which is both difficult to represent and compute. The reason for these problems is that derivatives are not defined everywhere on the fault manifold, for instance at the edges of the fault manifold, and that implicit surfaces require an inside and outside of a surface to be defined, but a manifold has no inside points. Therefore, the approach was taken to represent a segmented fault as the bounding surface of the fault's 2-D manifold (see FIG. 17). In FIG. 17, two views of the bounding surface of a fault's 2-D manifold are shown. Colored surfaces represent the actual 2-D fault manifold and silver surfaces are the bounding surface of the fault. This representation allows curvature to be defined at all points of the segmentation so that the actual fault surface can be segmented by a medial-surface extraction. An additional advantage to representing the segmented fault as a bounding surface is that it approximates a region called the fault damage zone, which is of interest to geoscientists conducting reservoir modeling.

The starting point for segmenting faults is the initial seeds, which are assumed to be either manually picked or automatically extracted. Level set seeding is covered in more detail hereinafter. Next, the initial seeds are represented as an implicit surface, which then requires a velocity function to drive growth for the accurate segmentation of faults. A natural representation for this function can be derived from the approaches described above. Given the success gained from using a fault likelihood measure for highlighting faults, this measurement is used as a basis for the level set velocity function. The fault likelihood is a scalar byte value ƒ from (0-255) and it can be thresholded for the level set velocity in a number of different ways. The goal of thresholding on the fault likelihood is to encourage growth in regions of high fault likelihood and shrinking in regions of low fault likelihood. The T term in the fault likelihood function specifies a threshold value around which faults are segmented. For the case of the sawtooth form (Equation 20), all voxels in the volume greater than T will grow and all voxels less than T will contract the level set. For the case of the triangle form (Equation 21), all voxels greater than T plus or minus some range (ε) will grow, while all voxels outside of this range will contract the level set. The result of their corresponding speed functions is shown in FIG. 18. In FIG. 18, the threshold-based fault velocity functions for the triangle (left) and the sawtooth (right) forms are illustrated.

F(i)=i−T Equation 20

F(i)=ε−|i−T| Equation 21

The threshold-based speed function is combined into the level set equation given as:

$$\frac{\partial φ}{\partial t} = \vert ∇ φ \vert [ α F ( I ) + β ( ∇ \cdot \frac{∇ φ}{\vert ∇ φ \vert} ) ] \qquad Equation 22$$

Where F(I) is the fault likelihood propagation function on volume I scaled by α. The term ∇·(∇φ/|∇φ|) is the mean curvature of the level set, scaled by β. As in other level set velocity functions, the coefficients α and β designate the amount of influence the terms of the equation have on the overall growth process. This velocity equation becomes more advanced with the addition of a feature exaggeration term as will be covered hereinafter, and using generalized advection constraints.

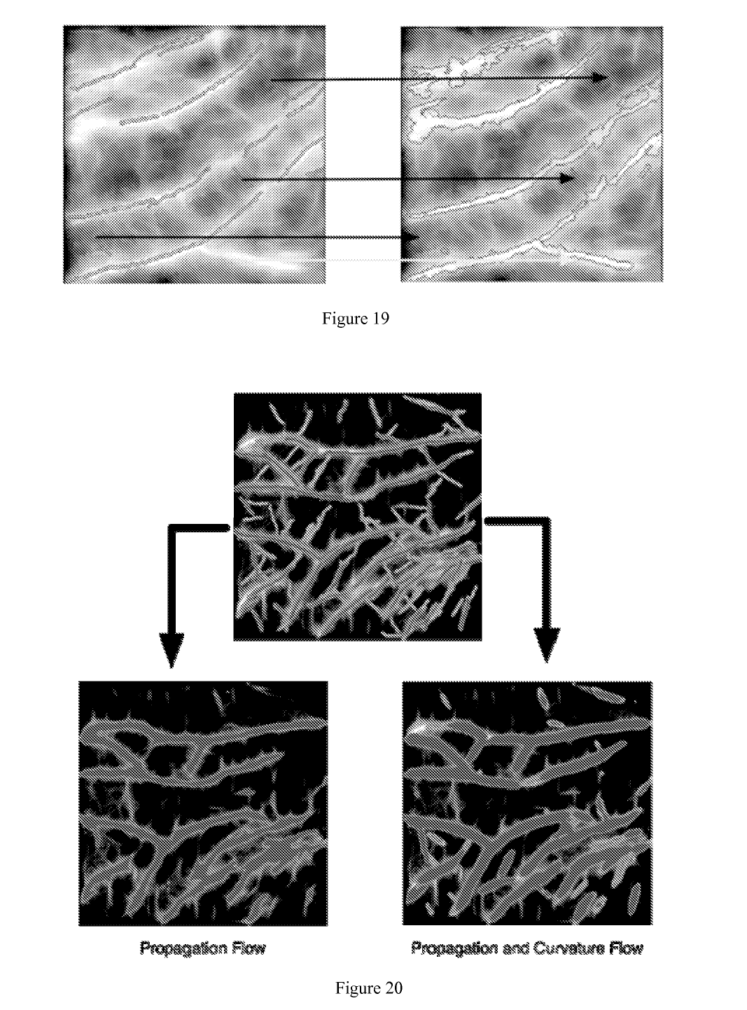

When level set growth is determined by parameters of fault likelihood and mean curvature there is a challenge to determine the proper weighting of these terms in the velocity calculation. The tradeoff is to prevent leaking growth of the fault into undesirable regions while still allowing controlled growth into faulted regions. This tradeoff is controlled by the β and β coefficients. Determining the optimal values of these coefficients required significant testing on a number of different data sets in order to properly model the behavior of fault growth. Computing multiple iterations of the level set evolution with a range of coefficient values allowed for a determination of which coefficients produced the best growth. FIG. 19 shows one time-slice view from iteration 0 and one slice at iteration 100 of a fault-likelihood based simulation where curvature had an effect of β=0.05 and fault-likelihood an effect of α=1.0. More specifically, in FIG. 19, an example of high-propagation evolution for (left) initial and (right) final time steps is shown. Background grayscale image is the fault-likelihood data overlaid in red by the level set fault extraction. Black arrows points to initial seeds that shrunk and yellow arrow points to a new fault region that the technique discovered. FIG. 20 shows one time-slice view from a dataset at iteration 0 and two slices at iteration 100. In one case (left) high propagation was conducted (α=1.0, β=0.0) and in the other case (right) high propagation was balanced with curvature (α=1.0, β=1.0). It can be seen that the curvature term has a regulating effect on the flow and maintains a more smooth evolution. More specifically, the figure illustrates comparing propagation only flow (left) to propagation flow with curvature flow (right) for the initial seeds (top). Blue represents the level set surface and red is the boundary of the surface. Bright features in the background image are faults and dark features are non-faults. It should be noted that it is convenient to show 2-D time-slice images on paper to describe the growth of fault evolution, although it is important to remember that this simulation is happening in 3-D. After completing tests on a variety of datasets, the optimal starting choice of these coefficients was determined to be α=0.125 and β=1.0. Any changes made to the velocity equation will result in a change of these coefficients and different datasets will likely require reconsideration of these values.

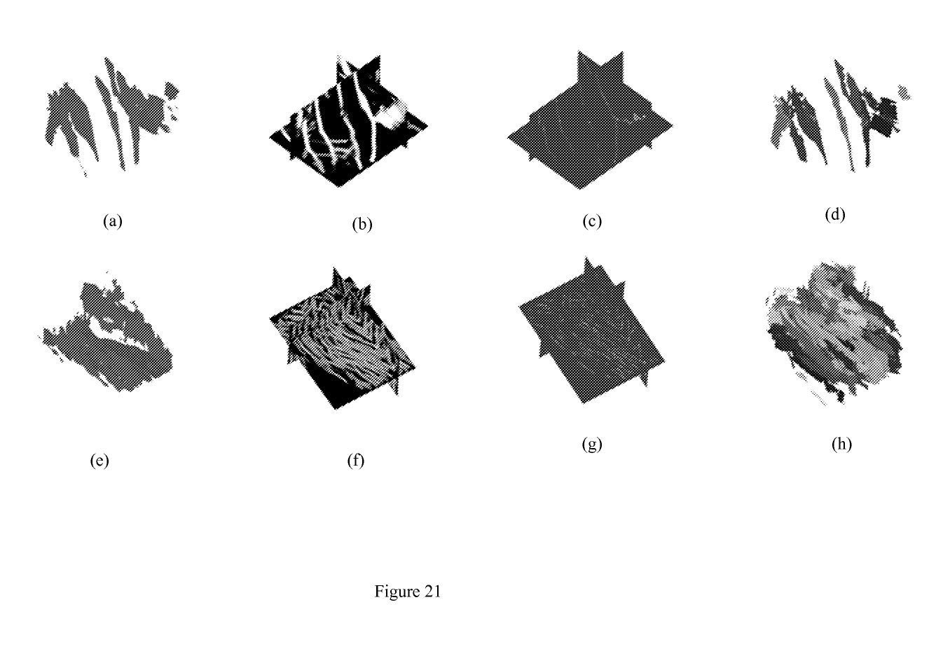

In analyzing the results of this process, the advantages of using the level set representation for segmenting fault features should be noted. In FIG. 19, black arrows represent initial features in the seed level set that did not grow into faults, or in other words, they shrunk. The yellow arrow points to a feature that was not found in the initial seed image, but after sufficient iterations, the level set evolution was able to expand into this fault region. In FIG. 21, medial-surface extraction and segmentation results from two different seismic datasets are shown. The top row shows Seismic-A and bottom row shows Seismic-B as (a,e): original level set simulation output, (b,f): level set distance transform, (c,g): medial surface slices, and (d,h): segmented components. FIGS. 17, 21, 27 and 33 illustrate these results in three-dimensions in order to describe more intuitively what this technique is accomplishing and the complexity of fault structures (i.e., intersecting and X-patterns) the system is able to represent.

In accordance with one exemplary embodiment, implicit surface visulation is a task that is well suited to being computed on a GPU (Graphics Processing Unit) due to the dense volumetric representation of the level sets and the localized finite differencing used to calculate derivatives. The level set algorithm developed to compute the implicit surface visulation will be described in the context of stream processing, which is a SIMD model of parallel processing described by a data set (stream) and an operation applied to the stream (kernel function). This model of processing is suitable for applications that exhibit high compute intensity, data parallelism, and data locality, all of which are qualities of the implicit surface visulation technique.

The streaming level set implementation comprises three major components: data packing, numerical computation, and visualization. The data packing focuses on optimally storing the 3-D level set function into GPU texture memory such that it can be accessed and indexed efficiently. The numerical computation of the level set should be done in a way that takes advantage data locality and maximizes compute intensity of a kernel function during each iteration. The visualization component comprises a marching cubes kernel that extracts and displays the implicit surface at every iteration.

An initial seed point is used to start a level set segmentation and this seed point should be represented by its signed distance transform in order to enable level sets to be computed. A signed distance transform represents the arrival times of an initial front moving in its normal direction with constant speed, which is negative inside and positive outside of the initial front. As mentioned, this is most often computed on the CPU using the fast marching method, which maintains a heap data structure to ensure correct ordering of point updates. Unfortunately, this technique does not map well to a streaming kernel due to the trouble of maintaining the heap structure on a GPU. Therefore an iterative method is used to allow the distance transform to be computed in-stream.

The fast iterative method (FIM) calculates the distance transform used for initializing the level set front. The FIM is an appropriate technique for streaming architectures, like GPUs, due to the way local and synchronous updates allow for better cache coherency and scalability. FIM works by managing a list of active blocks that are iteratively updated until convergence is reached. A convergence measure is used to determine whether or not blocks should be added or removed from the active list through synchronous tile updates.

In the thread decomposition paradigm, the threads that execute a kernel are organized as a grid of blocks. A block is a batch of threads that work together and communicate by sharing data through the local shared memory and can synchronize their memory accesses. Threads in different blocks cannot communicate or synchronize with each other. At the lowest level, a warp is a sub-set of threads from a block that gets processed at the same time by the microprocessor. Warps are issued in an undefined order by a thread scheduler and therefore cannot be synchronized, so the lowest level of thread synchronization occurs at the block-level. This block-independence is what allows the CUDA architecture to scale well because as more processing units are added to future devices, more blocks can be independently computed in parallel.

A block-based updating scheme is used during computation on the IVE such that a block of threads share resources and work in parallel to update blocks of the solution. In this work blocks are fixed to a size of 8×8×4 such that 256 threads are executed in parallel and have access to same region of the volume stored in shared-memory. A one-to-one mapping of threads to voxels is used in this implementation, such that a block of 256 threads computes the solution iteratively for blocks of 256 voxels until the entire grid of all voxels have been computed. For a grid size of 256³ voxels it takes approximately 256² individual block updates to compute a solution.

A 3-D array mapped to a texture is used to represent a volume on the GPU. The data is stored in 32-bit floating-point for both the input volumes and the level set volumes. It is necessary to store the level set volumes in floating point to ensure accurate calculations. Depending on the application, as many as four input volumes can be necessary for representing scalar values that control level set terms. In addition, at least two level set volumes are allocated for conducting a ping-pong computation where the active and result storage volumes are swapped each iteration. Along with these volumes, three large texture-mapped arrays are allocated for look-up tables to implement the isosurface extraction routine for storing edges, triangles, and numbers of vertices. Lastly, two vertex buffer objects (VBOs) are created for storing triangle vertices and normals used in rendering. It can be seen that this approach is greedy in its use of available GPU memory in order to enable fast computation.

In order to more efficiently move data from global to shared memory on the GPU, it should be stored in global memory (DRAM) in a way that allows reads to be as coalesced as possible. Coalesced memory accesses by a multiprocessor read consecutive global memory locations and create the best opportunity to maximize memory bandwidth. Therefore, packing a volume in global memory with the same traversing order as memory accesses made by the algorithm is the most efficient way to store a volume in global memory. This can be accomplished in a straightforward manner by re-ordering a volume such that 8×8×4 blocks of the volumes occur consecutively in linear memory. Next, the re-ordered volumes in global memory can be mapped to textures, which provides an opportunity for data to be entered in a local on-chip cache (8 KB) with significantly lower latency. With this combined approach, chances are significantly increased that when data is requested from global memory it will be cached either from texture-mapping or when requesting nearby memory locations. Memory reads are thereby optimized as long as there is some locality in the fetches. For the purposes of one exemplary embodiment, non-local texture fetches rarely need to be made since the level set computation requires access only to neighboring voxels in the volume. In practice, texture memory that has been cached can be accessed like an L1 cache (1-2 cycles) as compared to global (non-coalesced) memory reads that require a significant 400-600 cycle latency. In practice, these numbers will vary greatly depending on exact memory access patterns and how often the texture cache needs to be updated, which cannot be controlled by the programmer.

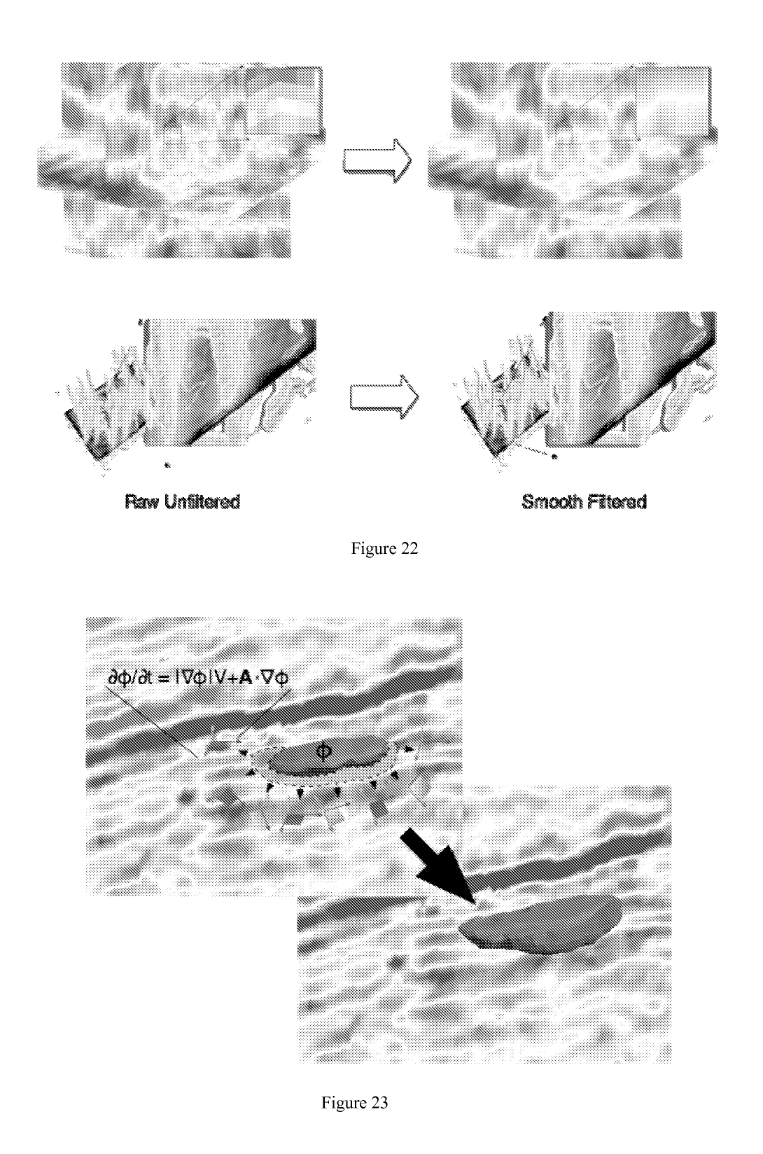

There are significant advantages to reading from texture memory as compared to global GPU memory, which is necessary to experience the full benefits of the GPU architecture. Textures act as low-latency caches that provide higher bandwidth for reading and processing data. In particular, textures are optimized for 2-D spatial locality such that localized accesses to texture memory is cached on-chip. Textures also provide for linear interpolation of voxel values through texture filtering that allows for easy renderings at sub-voxel precision (see FIG. 22—As shown in FIG. 22, tri-linear texture filtering on a seismic volume (top) and a level set volume (bottom) is shown. The left image is non-filtered and right image is filtered.) Data access using textures also provides automatic handling for out of bounds addressing conditions by automatically clamping accesses to the extents of a volume.

Since shared memory provides over 2 orders of magnitude faster access to data than global memory, it should be pre-loaded with data that is expected to be frequently used. Shared memory is first set aside for the storing the level set volume, since it is the volume most frequently accessed during computation of the evolving surface (e.g., when calculating finite differences). Blocks of size 8×8×4 comprise 256 floating-point values or 1 KB of shared memory. Since each SM (Streaming Multiprocessor) has 16 KB of shared memory available, additional data can be stored in the remaining memory. This memory should next be assigned to the bordering voxels around each block (˜1 KB) so that level set values computed on block edges do not have to access global memory. Next, we can store blocks of size 1 KB from any of the feature volumes that provide information for the level set terms such as the input seismic data or a fault likelihood volume.

Since shared memory, caches, and registers are shared by one or more blocks on a SM, there is a limit to how many blocks can be launched at one time. This depends on how many SM resources are required by a single block. Therefore, there exists a tradeoff between block sizes and the use of shared memory since larger block sizes will require more data to be accessed from shared memory, thereby reducing the amount of data that can be stored in the banks. An additional concern is that the 16 KB of shared memory is divided into 16 banks that allow for simultaneous access. When multiple banks are accessed at the same time (i.e., bank conflict), requests must be serialized which causes performance to degrade. Block sizes of 8×8×4 provide a good middle ground between resource allocation per thread as well as being large enough to hide memory latency through many parallel computations.

One of the many advantages of using an implicit surface representation for modeling geologic features, as opposed to an explicit representation like a triangulated mesh, is its ability to dynamically adapt to drastically changing topologies and maintain a stable representation during computation. A disadvantage with the implicit representation is that it poses a challenge to extracting and directly visualizing iso surfaces of the function, something that comes cheaply with an explicit surface representation. The natural way to visualize an implicit surface is using direct volume rendering, which renders the implicit surface directly in its native state on the GPU. This could be accomplished by using a ray-marching pixel shader to render the level set directly in the GPU texture. By marching rays through the volume and accumulating densities from the “3-D texture” as a stack of 2-D textures, a value for the level set can be rendered. Unfortunately, direct volume rendering is only a rendering technique and may not provide a final form of the surface that can be used for further processing and editing by geoscientists in a geologic model. More importantly though, is that volume rendering is much more computationally expensive than extracting an isosurface to visualize using marching cubes. In order to assure that the speed of the IVE is as fast as possible, an isosurface extraction technique can be used for visualization instead of volume rendering.

Isosurface extraction using the marching cubes algorithm extracts a triangulated mesh of the level set surface. This approach is desirable since the resulting surface is identical to the level set surface and can be used in the many mesh-based reservoir-modeling tools. For this reason, a new technique was developed for extracting the isosurface of a level set surface using a modified streaming marching cubes algorithm that allows for fast and easy visualization on the GPU. Marching cubes is efficiently implemented to run on the GPU in a way that extracts triangles directly from the level set representation. This approach requires no further processing or intermediate storage of triangles prior to rendering and is therefore able to run at interactive rates.

The first step is to classify each voxel of the level set surface based on the number of triangle vertices it will generate (if any). In this voxel classification step, the goal is to determine whether each vertex of a voxel is inside or outside of the isosurface (i.e., level set) of interest. Next, the process iterates over all voxels in the volume and records the number of vertices that lie within the isosurface. If there are no vertices found for a voxel that lies within the isosurface, that voxel is designated as inactive so that it will be skipped.

The next step is to compact all active voxels into a single array. This is accomplished by iterating over the array that designates whether or not a voxel is active, and in the case where it is active, the voxel's index is saved in a compacted array. In order to exploit parallelism during the isosurface extraction, a prefix sum (scan) is performed across the volume in order to determine which voxels contain vertices and compact those voxels into a single array, while ignoring empty ones with no vertices. This scan can be accomplished efficiently in parallel by using the prefix sum. This scan results in a compacted array that ensures for the remaining steps the only voxels being calculated are truly active. Well-balanced parallelism is then accomplished by evenly dividing this compacted array among GPU stream processors.

The final step is to iterate over the compacted active voxel array and generate triangles for rendering. This is done by simply checking all active voxels in the compacted array and calculating the points of their intersecting triangles. Since the compacted array contains the locations of vertices where the isosurface intersected a given voxel, 3-D point locations are readily available. The three points that make up the triangle are then used to calculate the surface normal for the triangle face using a cross product. The triangle vertices and normal vector are then saved into vertex buffer objects, which are buffers on the GPU for storing geometric data. Finally, the isosurface is displayed by rendering the triangles in the vertex buffer. The normals are used for calculating the lighting and shading of the triangles. The result is a triangulated mesh representation of the implicit surface that is readily visualized on the GPU and can easily be transferred to main system memory for post-processing and editing at the end of a simulation.

Advanced techniques for level set modeling and a fast GPU solver have been presented, so now the prospect of real-time structure analysis conducted on-the-fly as the level set evolves can be discussed. By conducting structure analysis on a narrow-band around the implicit surface in real-time, it allows geologic features to be imaged on the fly for driving surface evolution (see FIG. 23 where the calculation of the structure tensor on the seismic data around a narrow-band of the level set returns propagation and advection terms on the fly for use in surface evolution is illustrated). This can be a useful technique for analyzing data that cannot easily be pre-computed by standard structure analysis, for adaptive segmentation of simple shapes, and for situations where input data is being received in real-time and must be immediately processed before it changes.

The techniques described use implicit surfaces to model geologic features require many level set terms (propagation, advection, etc) to be calculated before the implicit surfaces can be computed. The reason for this is largely due to computational efficiency, since it is more efficient to compute these terms all at once for the entire domain rather than on an as-needed basis. The advent of GPGPU (General-Purpose computation on GPUs) is providing significant changes to this paradigm by allowing for greater interaction and faster responses to data interrogations. The GPGPU paradigm provides sufficient computational power to calculate many level set terms on the fly in a way that steers the level set surface in real-time. This removes many of the requirements to pre-process the structure analysis of an input volume before it can be interpreted using level sets. This also provides geoscientists with a more immediate response to their interrogations.

For applying this technique to seismic data features, the structure analysis techniques described need to be written as a kernel. Although the existence of a kernel has already been mentioned, it has not been defined in what it means for this particular application. A kernel refers to a function that is called on a single voxel and returns some value based on the structural analysis of an input dataset and/or topological properties of an implicit surface. This value is intended to be used as a term in the level set evolution. In the previous section, the 3-D edge detector was a kernel used to generate a propagation term.

Following from the definition of a kernel, it seems straightforward to implement the structure analysis techniques as function calls for a given voxel. Unfortunately this approach does not take advantage of the volumetric representation of the input data or the level set representation, and therefore many redundant calculations result. In particular, in the case where a kernel is being calculated on an input dataset that is constant and never changes, a single voxel may have its kernel calculated multiple times. This is not a problem for a dataset where the ratio of feature to non-feature is very low, meaning the final surface will be small in relation to the size of the volume. In the case where the ratio of a feature to a non-feature is very large, such as if the final surface encompasses a large part of the input volume, this becomes a significant inefficiency. The reason is two-fold.

First is the already mentioned fact that as the narrow-band of the level set computation moves through the volume, the same voxel will have its kernel calculated multiple times possibly resulting in redundant calculations. Second is that many of the structure analysis techniques require a series of calculations on a region of voxels around the voxel in the kernel. This regional computation becomes more pronounced in operations that conduct smoothing on a region of voxels around a center voxel, as the region of influence can be quite large. When a smoothing operation is cascaded by a subsequent computation that also requires a region of voxels, the previous operation must be first computed for each of the voxels in the region. The result is that for cascaded operations requiring a region of voxels, the kernel paradigm becomes far more computationally intensive than pre-calculating the level set terms at one time. Therefore, the kernels described in this section are adapted for simple structure analysis techniques and assume the input volume has been previously smoothed.

In order to calculate structural attributes of faults and channels in seismic data, the local horizon or stratum must first be found at a given location in the seismic data. This requires first calculating the structure tensor by finite differences and then finding the sorted eigenvalues and orthonormalized eigenvectors of the structure tensor. Since in the GPU implementation both the level set domain and the seismic data are stored in 3-D texture-mapped memory, memory values can be quickly retrieved for use in very fast derivative calculations for generating the structure tensor.

Next, the eigenvalues and eigenvectors of the structure tensor must be determined. This is accomplished by using a noniterative algorithm from the medical imaging community. For solving the eigensystem, an algorithm was chosen that does not require iteration in order to allow fast calculations of eigenvalues and eigenvectors that leverage the high computational throughput of, for example, a general purpose parallel computing architecture that leverages the parallel compute engine in NVIDIA graphics processing units (GPUs) to solve many complex computational problems in a fraction of the time required on a CPU (CUDA). Iterative techniques can decrease the throughput of the GPU if they are not taking advantage of the large number of calculations that can be quickly computed on the GPU.

After having a representation of the structure tensor and its eigenvalues and eigenvectors, it is straightforward to determine the kernels described for imaging faults and channels. The kernels are computed during each block update of the level set domain that was described. As every voxel in the evolving level set surface is solved, the feature kernel is first computed then the resulting values are immediately used in the level set equation. This order of computations is important because it results in feature kernels only being computed when the evolving surface is driven into that region of the volume. This also provides a layer of adaptivity to the technique since kernels can use information about the current position and shape of the implicit surface into the parameters and orientations of their computation.

All level set evolutions require a seed or set of seed points from which the evolution begins to grow. One standard way for accomplishing this is by using a shape-prior model, which approximates the object being segmented and helps the evolution proceed to a solution faster. Another more obvious way is by a manual seed, which is picked or drawn into the segmentation by the user. A number of techniques are described for creating seed inputs to level set evolutions for seismic interpretation applications. This section focuses on applications to fault segmentation, although the techniques described are generally applicable to other features.

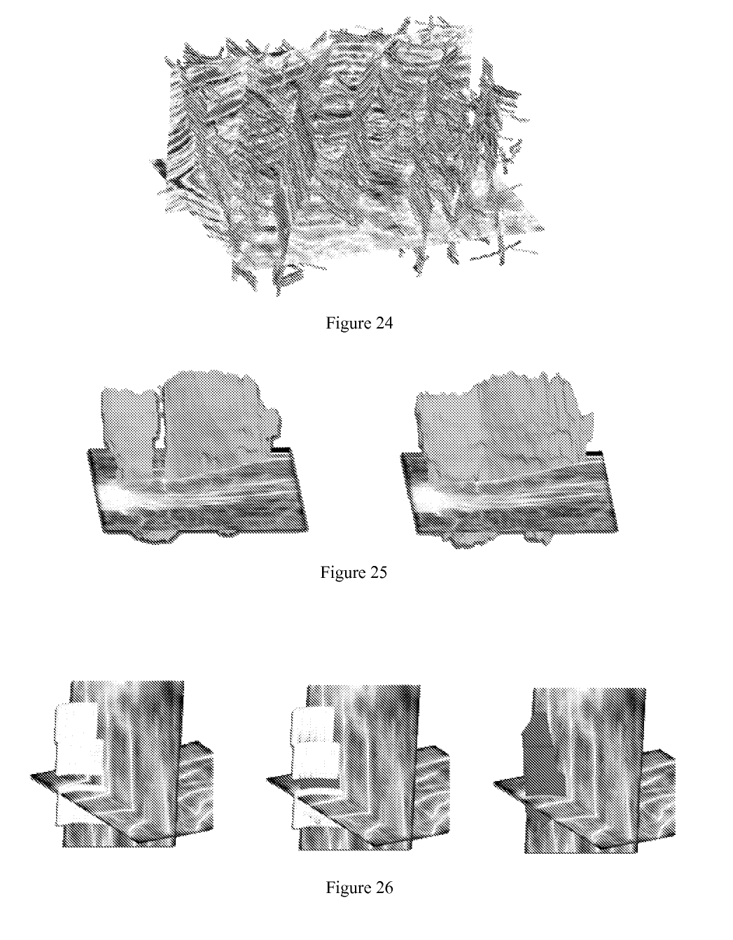

Automatic seeds can be generated using techniques that approximate the location of features of interest. One exemplary goal of these techniques is that they are fast to compute and their approximation to the feature of interest is close enough to at least intersect at one point. In the case of geologic faults, an automatic seed input can come from a lineament extraction technique that auto-tracks peaks or from a traditional Hough transform operated on 2-D time slices of a 3-D volume. Both of these techniques attempt to trace features two-dimensionally (i.e., on horizontal slices) by following peaks in an attribute volume such as channelness or a fault likelihood volume. FIG. 24 shows an example of automatically extracted lineaments that approximate fault locations. In FIG. 24, automatically extracted seed lineaments for seed points to the level set are shown where different colored lineaments represent distinct seeds that are approximated to align with faults in the data. For the case of channels, automatic seeds are more difficult to generate due to the complexity of channel attribute volumes and the high-likelihood of false-positives. The same holds true for identifying other geobodies, which is why the seeding techniques discussed hereinafter are recommended for that purpose.

The use of local orientation information between features can help improve on the manual merging technique by identifying which surface patches are good candidates to be combined. This describes a new technique called “smart merging.” Two surfaces are often manually merged together if they have a common orientation and a close distance to each other. Therefore, using a smart merging technique would make it possible to pre-empt the merging decisions a user would make on their own.

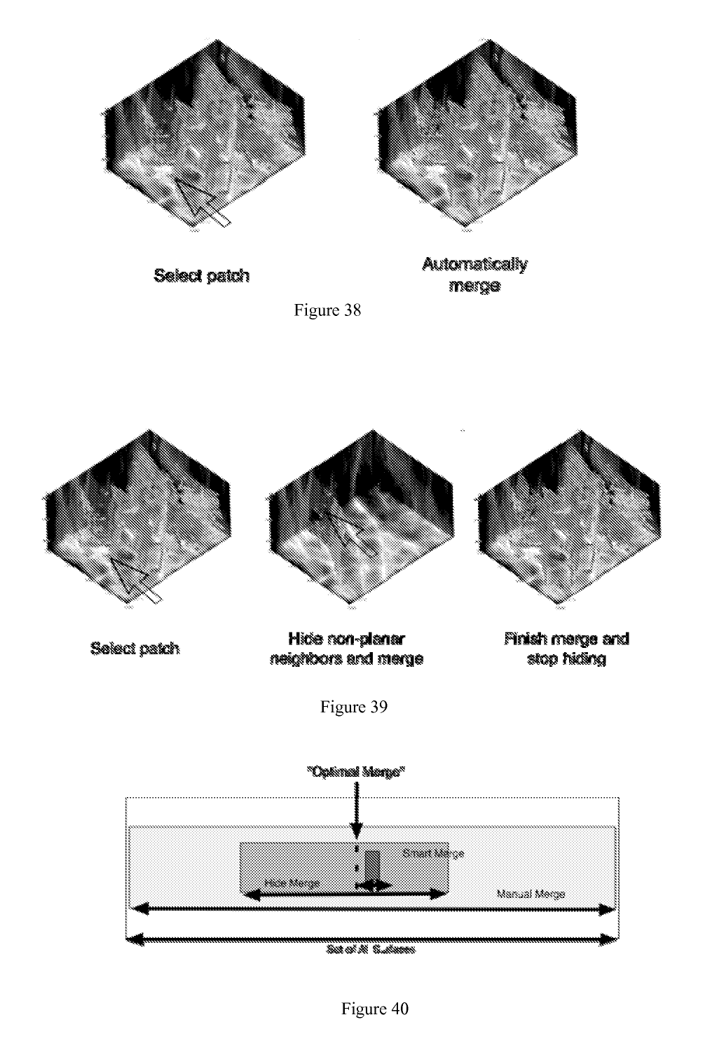

FIG. 38 illustrates an example of Smart Merging by selecting a patch for consideration (left) then highlighting all patches that meet the distance, normal dot product, and coplanarity constraints. (right) Highlighted points are then automatically merged into a new feature.

The smart merge works by when a surface patch is first selected for merging, a search is made for all other surface patches being displayed that are a given distance away. The distance is measured between two sets of points by using the distance of their midpoints. Although the midpoint approximation is not the most accurate way to compare the distance between two patches, it is fast and when the patches being used are compact it performs well. For those patches that are within the distance cutoff, their orientation is then compared to the first-selected patch. There are many ways to compare the orientation between two surface patches; the technique used here is to calculate the dot product of the normals and the coplanarity between the two patches. The dot product between the two normals is close to 1.0 when the normals are pointing in the same orientation. Coplanarity is calculated by taking the dot product of the first patch's normal with the vector between the two midpoints of the patches. This dot product is close to 0.0 when the patches are coplanar. The results of these calculations are compared to three user-defined parameters: minimum distance, minimum normal dot product, and maximum coplanarity dot product. If the result passes each of these parameter tests, the current patch in the search queue is automatically merged with the selected patch.

Another way of thinking about the smart merging technique is as a lightweight clustering technique. Above was described a complex clustering and segmentation technique for combining a large surface into discrete components. When choosing clustering parameters a choice is made between erring on the side of over-segmentation (i.e., creating too many patches) or under-segmentation. Since it is generally easier to combine two discrete patches into one than it is to break an under-segmented component into two pieces, a default of over-segmentation is preferred. Unfortunately, due to the simplicity of the smart-merging technique compared to the more complex clustering and segmentation techniques, it may make wrong decisions by merging together two patches that shouldn't be merged. Therefore, the technique allows for easy undo operations if the result is less than desirable.

FIG. 39 illustrates an example of Hide Merging by (left) selecting a patch for consideration then (middle) hiding all patches that do not meet the distance, normal dot product, and coplanarity constraints (right). The user can then manually choose which patches to merge with the patches still left displaying.

Motivated by the techniques developed for smart merging, a more effective technique was created for assisting with the merging of many discrete surface patches. Hide merging essentially works the opposite of smart merging by simplifying the visual display through hiding all patches that are certainly not going to be merged with the patch under consideration (See FIG. 39). The technique for determining which patches to hide is the same as discussed in relation to interactive steering only that the interpretation of the parameters are inverted. FIG. 40 shows the relationship between smart merging and hide merging. In practice, hide merging is more useful than smart merging because it continues to provide users with a level of manual control that does not exist for smart merging. Since hide merging only limits the number of patches that are displayed, it can be thought of as a sort of occlusion rendering technique that limits the rendering of patches that are not relevant to the surface patch being investigated. The user is then still able to use domain knowledge about the nature of features being combined, albeit with less clutter on the screen.

Semi-automatic seeds comprise using the previous output of a level set evolution as the input to a new simulation. This approach can be used as a way to iteratively segment by using the output of a previous level set simulation as the input to a later simulation. This may be a desired order of operations if a user does not know how much evolution is necessary to segment a feature, and if not enough evolution was done previously so that the process can continue evolving further. Continuing a level set evolution that has reached its final iteration can be considered a special case of a semi-automatic seed. FIG. 25 shows an example of a fault that was segmented using the planar level set approach (left) and afterwards using it as the input to a second level set evolution so that the gap can be filled-in, resulting in a better segmentation (right).

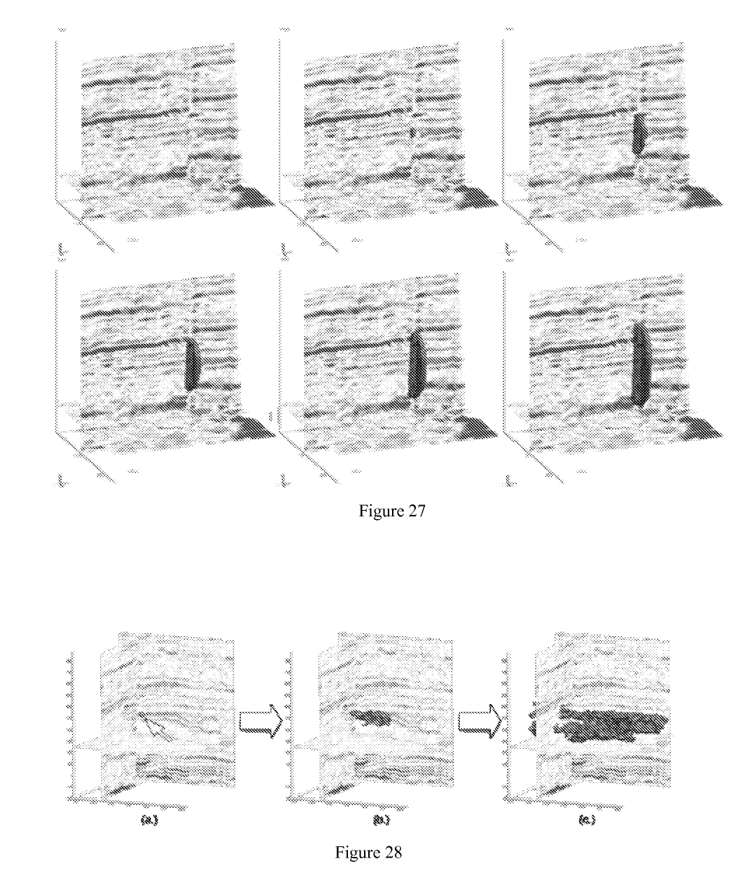

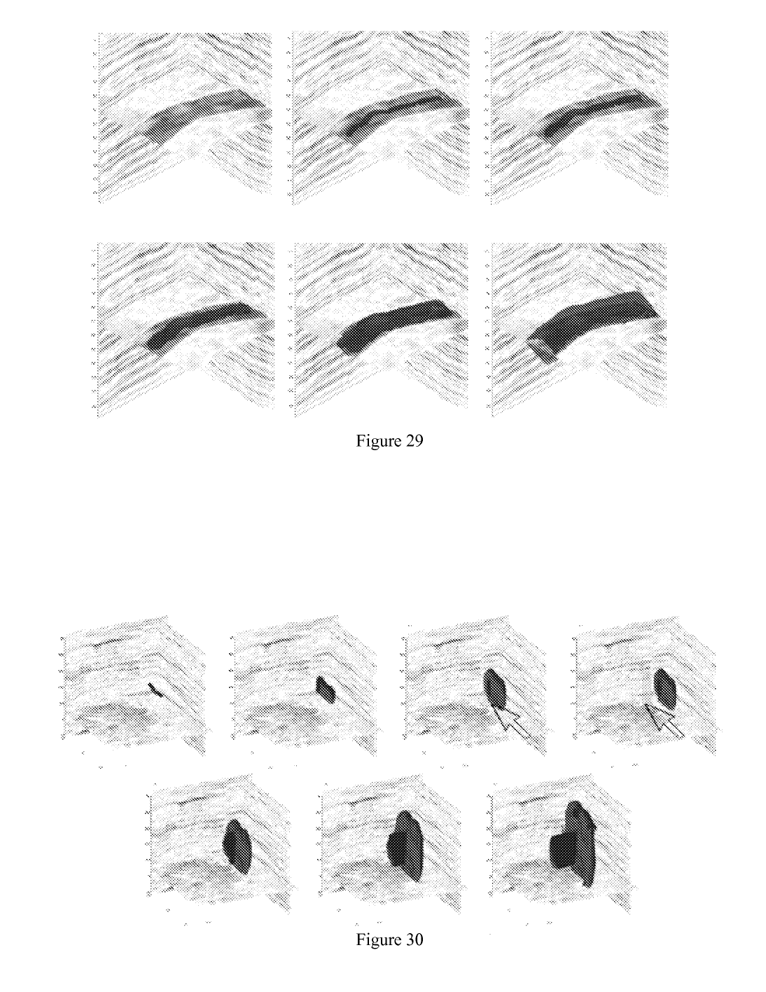

Manual seeds are hand-drawn into the computer using an interaction technique similar to “painting.” This is the most versatile technique for creating seed points since it gives a user the most control over the process, but it also can be more time consuming than automatic and semi-automatic seeds. The manual seeding has been implemented in two ways by using either a cubic paintbrush that can be elongated in any direction or a point set dropper that places points at mouse cursor locations. In either case, the user moves along 2-D slices in the 3-D volume and places seeds at places that approximate the location of features. The result of the painting procedure is then used as the initial zero level set for segmentation. The different use cases between the two approaches are that the cubic paintbrush is typically used to enclose a feature of interest (as in FIG. 26), whereby the surface shrinks and collapses around the feature with some outward growth. The point set dropper is used to define a sparse starting point that definitely intersects the feature of interest, thereby allowing the surface to grow extensively into the feature with minimal inward growth (see FIG. 27 which illustrates a time series computed on the GPU (left to right, top to bottom) showing a fault surface evolving from a seed point in a seismic dataset, FIG. 28 which illustrates segmentation of a high-amplitude geobody in a 3-D seismic volume showing (a) user defined seed point to start evolution, and where (b) and (c) show the extracted isosurface of the level set while it evolves at 50 and 200 iterations respectively and FIG. 29 which illustrates a time series computed on the GPU (left to right, top to bottom) showing a channel surface evolving from a line of seed points).

Previous sections have described techniques for level set methods that model a wide variety of features, but there still exists a need to modify these evolutions in an interactive setting. The interactive guiding of level set evolution, also called interactive steering, can be accomplished through careful modifications of the velocity function. Applying user-defined control to the level set surface in this way allows growth and shrinkage in specific, which is the desired functionality.

Interactive steering is implemented using a shaped 3-D paintbrush, which defines the region of the surface where growing and shrinking occurs. Since both the implicit surface and the propagation function are stored in a volumetric format, there are two potential ways to approach this topic. The first approach is to modify the surface directly by applying the 3-D paintbrush to the implicit surface volume. This requires dynamically modifying the distance transform representation of the implicit surface in order to redefine the zero-valued surface to encompass the changes made by the paintbrush. The implementation of this approach requires a reinitialization of the distance transform representation such that the user-defined modifications are treated as a zero crossing that is intersected with the implicit surface. In the case of growth the logical union of the zero crossings is the result and in the case of shrinkage the result is the logical difference of the implicit surface zero crossing with the zero crossing of the user-defined modification. The background motivation for this approach based on CSG modeling was described above. After the combination of zero crossings is complete, the domain needs to be reinitialized so that it again correctly represents a distance transform volume.

An alternative way to implement growth and shrinkage based on user-defined modifications is to work indirectly by changing the underlying velocity function, which in turn modifies the implicit surface (after a few iterations). This is one approach that was developed due to its simplicity and speed. Since the first approach requires recomputing the distance transform, a computationally expensive move, it is usually preferable to compute the surface evolution for extra iterations in order to encompass the modifications via the velocity function. Although, there is a point at which recomputing the distance transform volume requires less computation. This occurs when user-defined modifications significantly modify the implicit surface to the point that a large number of iterations would be necessary to evolve the surface into a new shape.

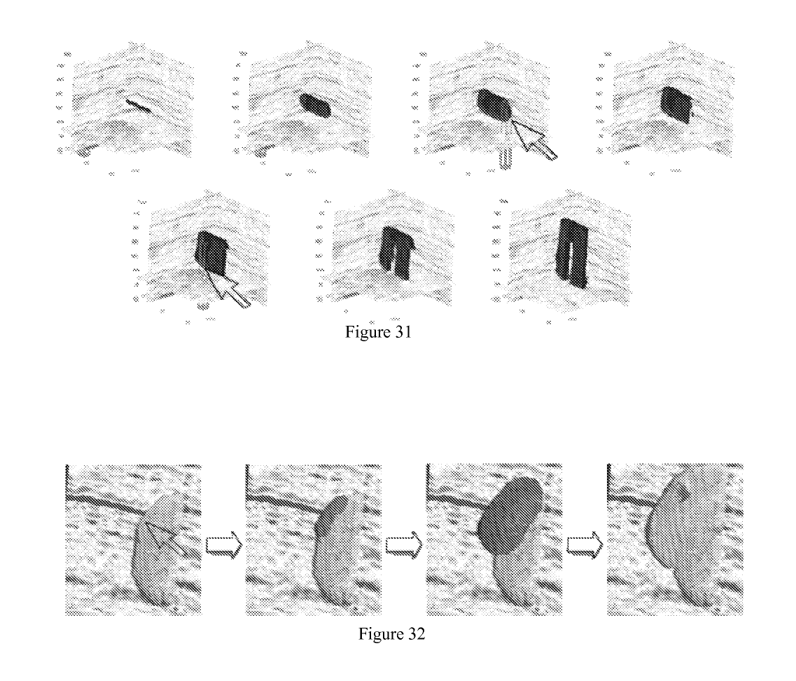

The velocity function modifying approach works by using the 3-D paintbrush to directly assign velocity values to the volume representing the evolution velocity. In the case of growth, positive propagation values are assigned by the paintbrush to the velocity volume, and in the case of shrinkage negative propagation values are used to retract the surface. This allows for the real-time modification of the surface as shown in FIG. 30 for growing and FIG. 31 for shrinking using an elongated cubic paintbrush. This technique finds use for preventing a surface from evolving into an incorrect region of the dataset or for encouraging the surface to evolve into a region of the dataset that it would not otherwise. Allowing all the interaction to take place in real-time fully represents a working implementation of computational steering.

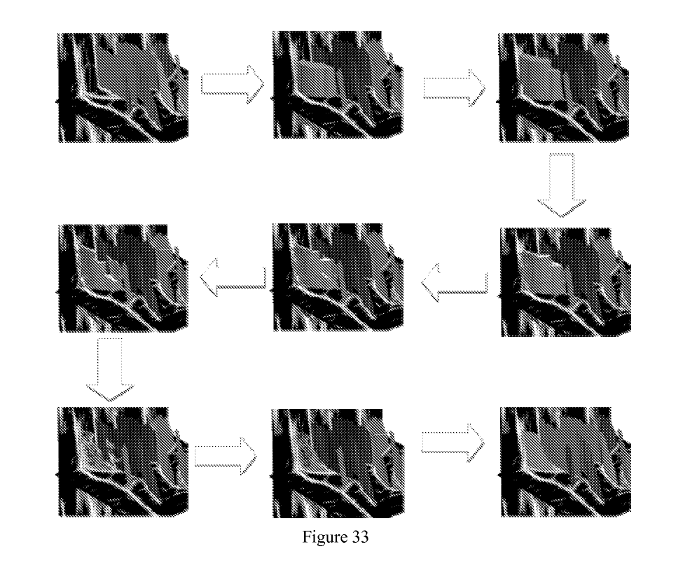

The techniques presented for level set modeling based on the paradigm where an initial seed computes a final solution surface needs to be expanded for situations where a surface requires further evolution in specific regions in order to fully describe a feature. Therefore, a technique is presented for allowing an existing implicit surface to expand or shrink in specific regions while the remainder of the surface remains fixed. Instead of using a shaped 3-D paintbrush to accomplish this approach, the technique described for manual seed points using a point set dropper can be employed. Since there is already an existing representation of the implicit surface available, seed points can be drawn directly on the region of the implicit surface where growing or shrinking should occur (see FIG. 32, where from left to right, adding blue seed points to the edge of a surface then evolving it for 30 iterations results in an extended version of the implicit surface). After these seeds are defined a new implicit surface is created and evolved using one of the velocity functions presented herein. Next, when the specific region finishes evolution, it is merged with the original implicit surface and a new distance transform is computed to generate the final surface (see FIG. 33 where evolution of fault based on a manual seed is shown, followed by merging and surface creation). This steering technique allows the interactive modification of surfaces by restricting evolution to user-defined parts of a surface in order to fully represent features.

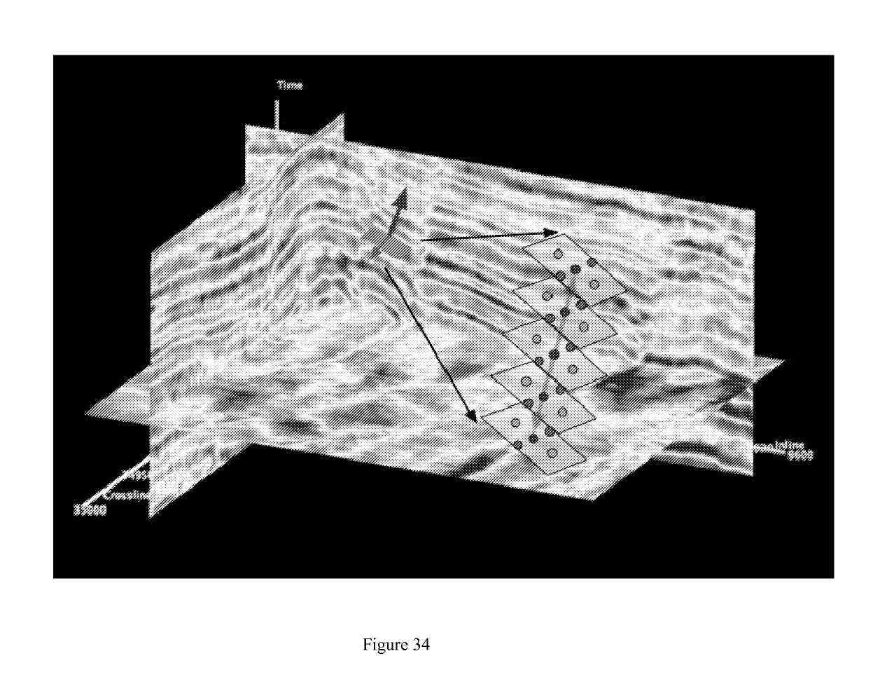

In FIG. 34, an exemplary illustration of how a fault feature can be imaged in seismic data by computing a vertical summation of discontinuities along the seismic strata is shown.

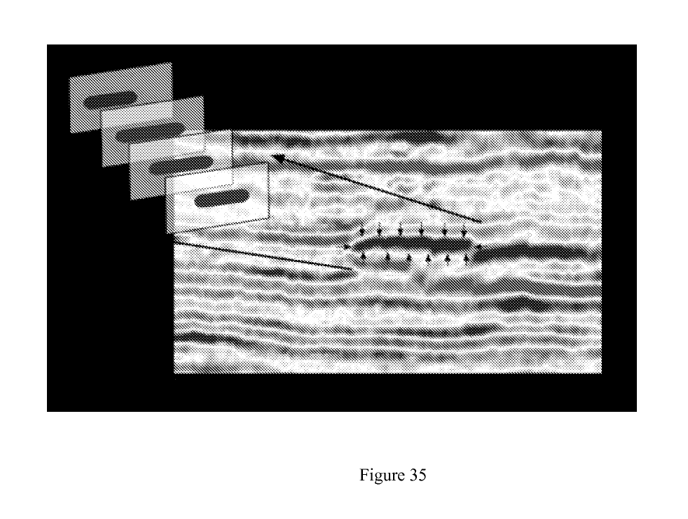

In FIG. 35, an exemplary illustration of how a geobody feature is imagined in seismic data as a set of connected voxels with similar seismic amplitude characteristics is shown.

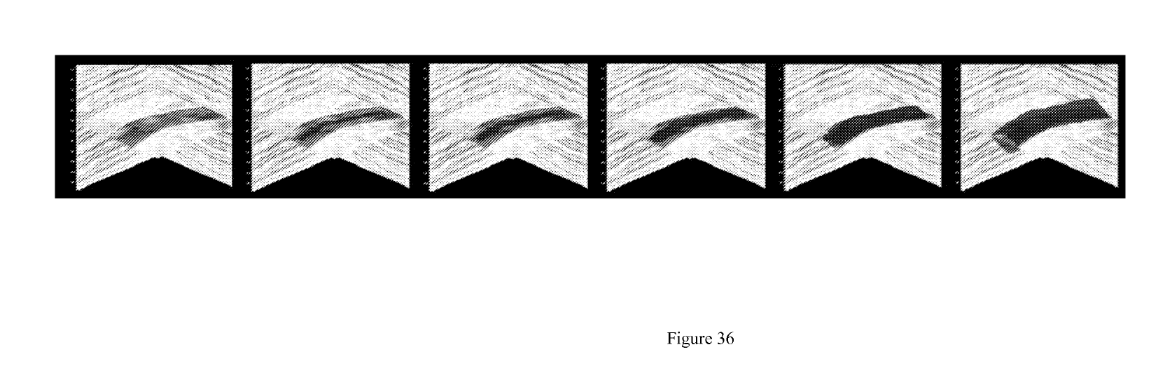

In FIG. 36, segmentation of an exemplary channel in a 3-D seismic volume showing user defined seed points (left) to start the growth is shown, followed by the surface evolving from 0 to 200 iterations (from left to right).

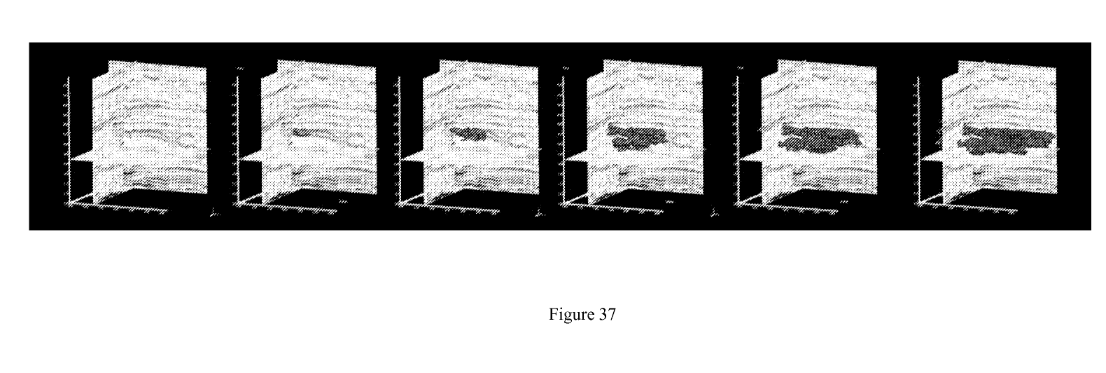

FIG. 37 illustrates an example of segmentation of a high-amplitude geobody in a 3-D seismic volume showing user defined seed points (left) to start the growth, followed by the surface evolving from 0 to 200 iterations (from left to right).

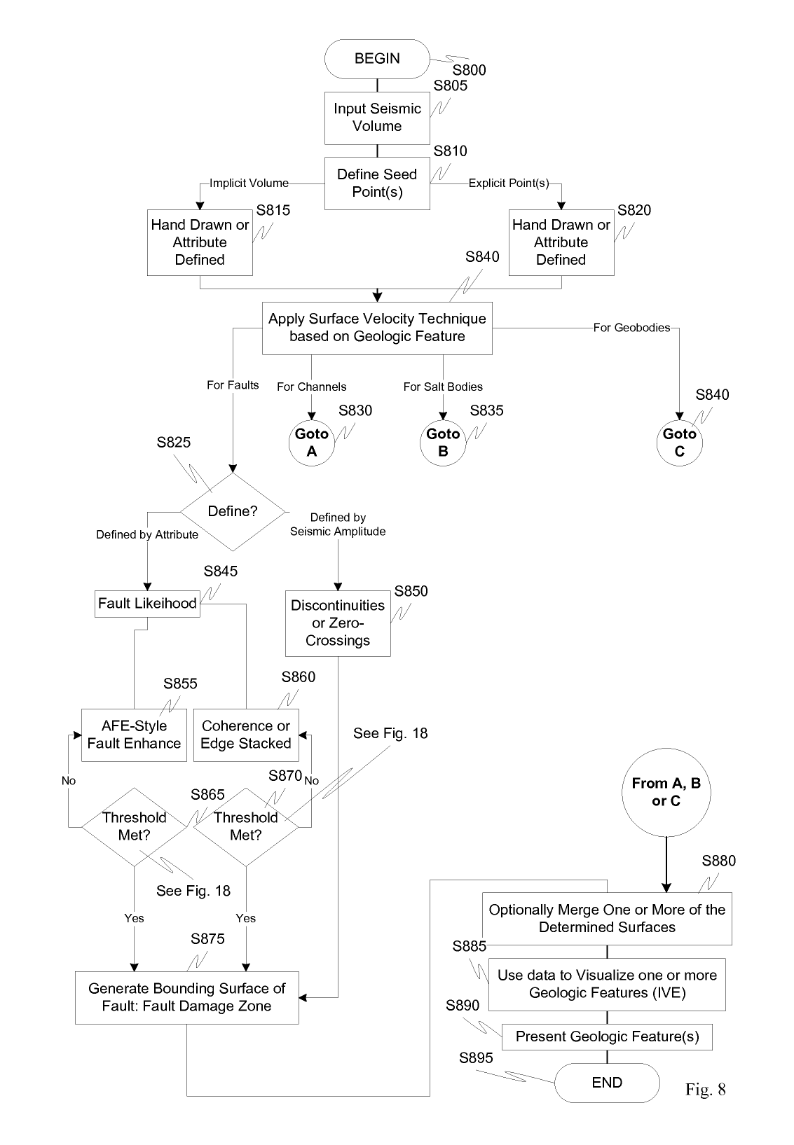

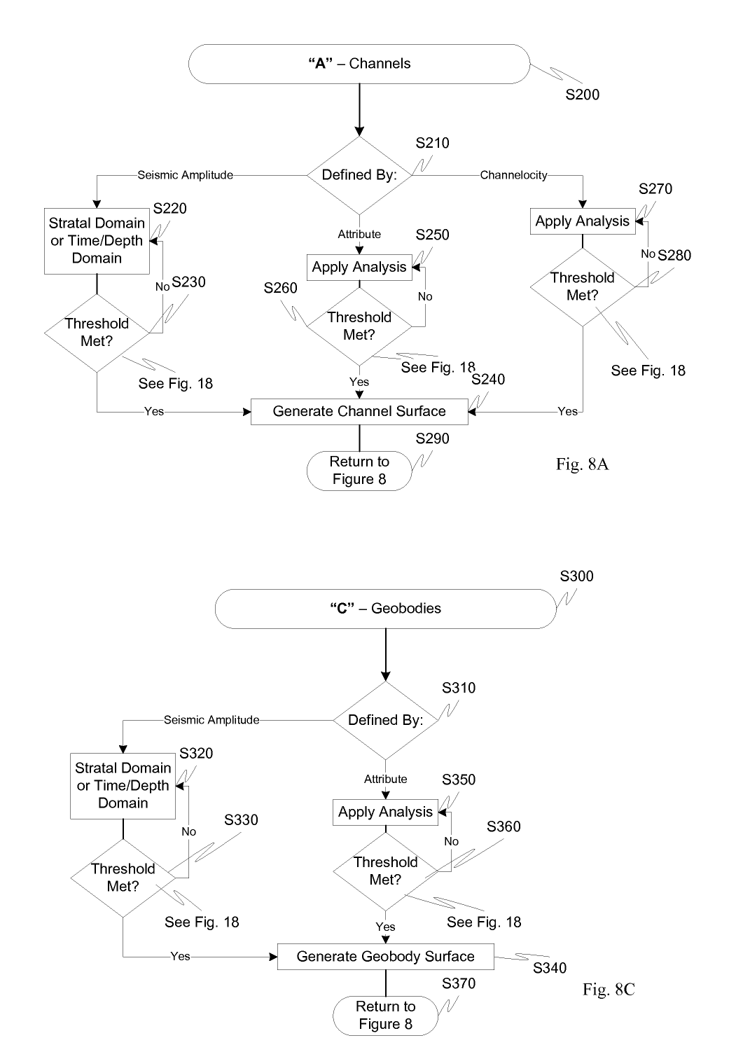

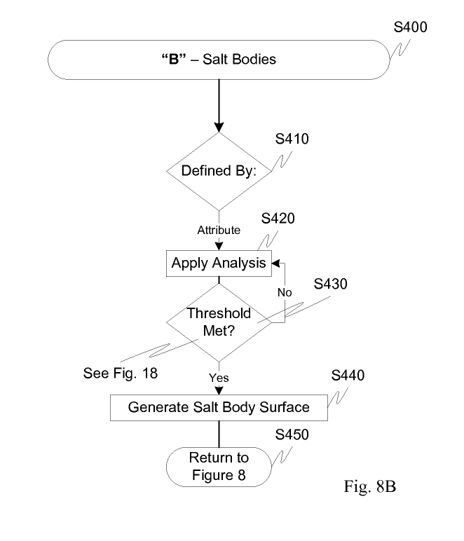

FIG. 8 illustrates an exemplary method for developing an interactive visualization environment according to an exemplary embodiment of this invention. In particular, control begins in step S800 and continues to step S805. In step S805, a seismic volume is input. Next, in step S810, seed points are defined. These seed points can be defined in accordance with an implicit volume or by the declining of explicit points. For either of these two options, the points can either be hand-drawn or attribute-defined in step S815 or step S820. Control then continues to Step S-840.

In step S840, a surface velocity technique is applied based on the specific type of geologic feature for which modeling and visualization is desired. For example, for faults, control continues to step S825. For channels, control continues to step S830. For salt bodies, control continues to step S835. For geobodies, control continues to step S840.

In step S825, a determination is made whether the fault is to be defined by attribute or defined by seismic amplitude. If the fault is to be defined by attribute, control continues to step S845, with control otherwise continuing to step S850 if it is defined by seismic amplitude. Next, in step S845, fault likelihood is determined with control continuing to step S855 if it is an AFE-style fault enhanced volume or to step S860 if it is a coherence or edge stacked volume. Then, in step S865 and step S870, respectively, a determination is made whether a threshold has been met. For example, one is directed toward FIG. 18 and the corresponding description thereof for determining whether a threshold has been met. As discussed, this can be a voxel-by-voxel progression throughout a portion of the inputted volume until a surface defined by one or more voxels has satisfied the thresholding criteria. Control then continues to step S875 where a bounding surface of the fault is generated. Control then continues to step S880.

In step S880, one or more of the determined surfaces can optionally be merged. Next, in step S885, the data representing the geologic body is used to visualize, for example, on a computer display, the one or more geologic features. These features are then presented in step S890 with control continuing to step S895 where the control sequence ends.

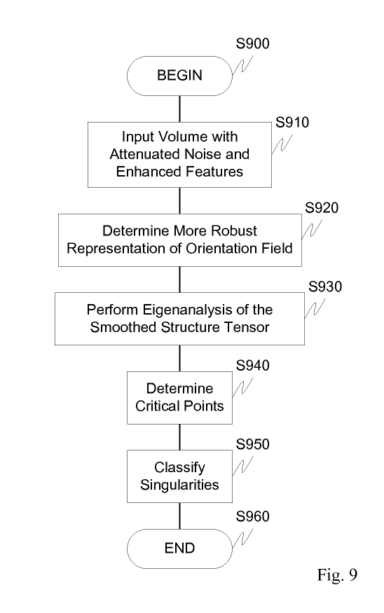

FIG. 9 outlines an exemplary method for structure analysis according to an exemplary embodiment of this invention. In particular, control begins in step S900 and continues to step S910. In step S910, an input volume is received that has attenuated noise and enhanced features. Next, in step S920, the more robust representation of an orientation field is determined. Then, in step S930, an eigenanalysis of the smooth structure tensor is performed. Control then continues to step S940.

In step S940, one or more critical points are determined. Next, in step S950, singularities are classified with control continuing to step S960 where the control sequence ends.

FIG. 8A illustrates and exemplary method for channel identification according to this invention. In particular, control begins in step S200 and continues to step S210. In step 5210, a determination is made whether the channel should be defined by seismic amplitude, attribute or channelocity. If defined by seismic amplitude, control continues to step S220 with control otherwise continuing to step S270.

In step S220, the stratal domain or time/depth domain is determined. Next, in step S230, a determination is made whether the threshold has been met. If the threshold has not been met, control jumps back to step S220 with control otherwise continuing to step S240.

If the channel is defined by attribute, control continues to step S250 where, in conjunction with step S260, a determination is made whether the threshold has been met. Upon finding the boundaries of the surface, control continues to step S240.

In step S270, a similar procedure is performed based on channelocity. Again, when a threshold is met, control continues to step S240 with control otherwise jumping back to step S270.

In step S240, a channel surface is generated with control continuing to step S290 where the control sequence ends.

FIG. 8C outlines an exemplary method for geobody visualization according to an exemplary embodiment of this invention. In particular, control begins in step S300 and continues to step S310. In step S310, and if the geobody is to be defined by seismic amplitude, control continues to step S320. Otherwise, control continues to step S350 based on being defined by attribute.

In step S320, and based on either analysis in the stratal domain or the time/depth domain, an analysis is performed and a determination in step S330 made whether a threshold has been met. If a threshold has been met, control jumps back to step S320 with control otherwise continuing to step S340. A similar methodology is applied if the body is defined by attribute with an analysis of the data occurring in step S350 and control continuing to step S360 to determine whether a threshold has been met. If a threshold has been met, control jumps back to step S350 with control otherwise continuing to step S340.

In step S340, one or more of the geobody surfaces are generated with control continuing to step S370 where the control sequence ends.

FIG. 8B illustrates an exemplary method for salt body visualization according to an exemplary embodiment of this invention. In particular, control begins in step S400 and continues to step S410. In step S410, and when the body is defined by attribute data, control continues to step S420 with an analysis of the data to determine whether or not the thresholding criteria have been met. If the thresholding criteria have not been met, control jumps back to step S420 with control otherwise continuing to step S440. In step S440, one or more salt body surfaces are generated with control continuing to step S450 where the control sequence ends.

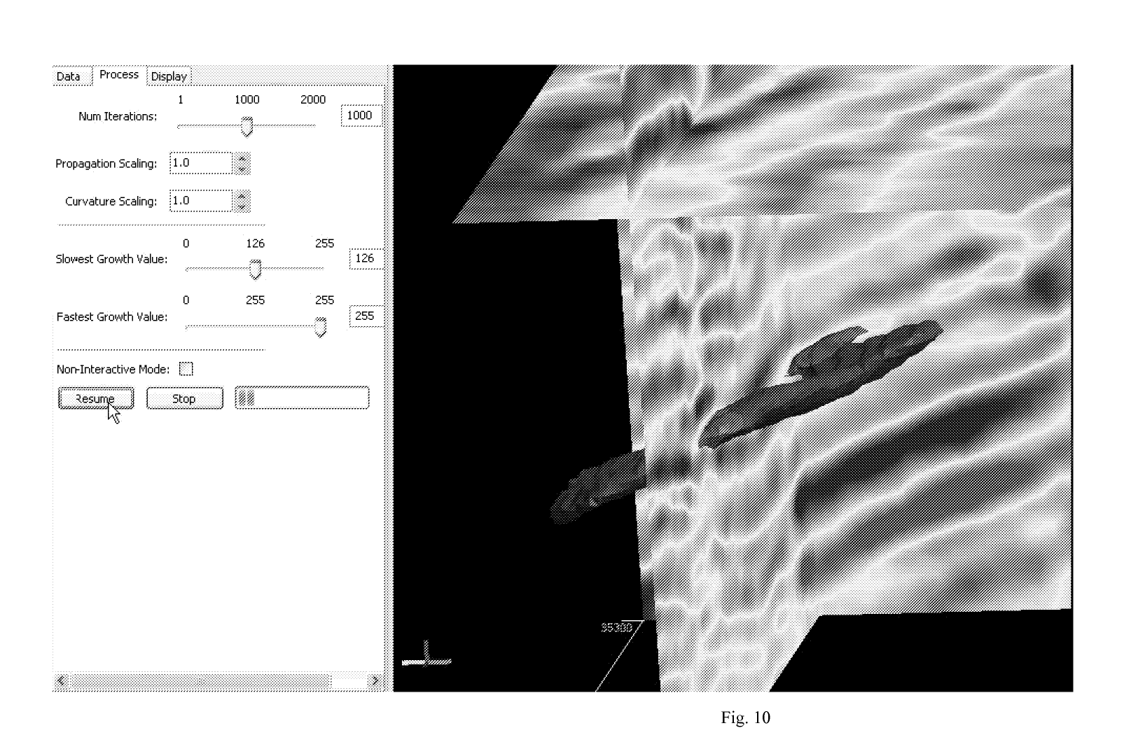

FIG. 10 illustrates an exemplary user interface that can be used with the systems and methods of this invention. For example, user-controlled parameters can be adjusted in the Graphical User Interface (GUI) of the IVE (Left) and the results of the changes can be immediately computed and visualized in the 3-D graphics window (Right). As shown the parameter adjustments can be made via a selectable portion, such as a slider and optional numerical input and such items as iterations, scaling, slowest growth value and fastest growth value controlled.

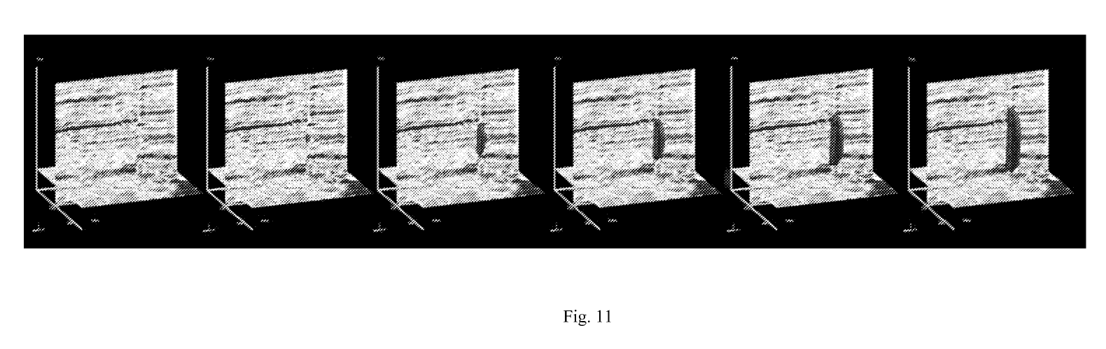

In FIG. 11, the segmentation of a fault in a 3-D seismic volume is illustrated. Here, user defined seed points (left) to start the growth, followed by the surface evolving from 0 to 200 iterations (from left to right).

While the above-described flowcharts have been discussed in relation to a particular sequence of events, it should be appreciated that changes to this sequence can occur without materially effecting the operation of the invention. Additionally, the exact sequence of events need not occur as set forth in the exemplary embodiments. Additionally, the exemplary techniques illustrated herein are not limited to the specifically illustrated embodiments but can also be utilized with the other exemplary embodiments and each described feature is individually and separately claimable.

The systems, methods and techniques of this invention can be implemented on a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, any means, or the like. In general, any device capable of implementing a state machine that is in turn capable of implementing the methodology illustrated herein can be used to implement the various methods and techniques according to this invention.

Furthermore, the disclosed methods may be readily implemented in processor executable software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The systems, methods and techniques illustrated herein can be readily implemented in hardware and/or software using any known or later developed systems or structures, devices and/or software by those of ordinary skill in the applicable art from the functional description provided herein and with a general basic knowledge of the computer and geologic arts.

Moreover, the disclosed methods may be readily implemented in software that can be stored on a computer-readable storage medium, executed on programmed general-purpose computer with the cooperation of a controller and memory, a special purpose computer, a microprocessor, or the like. The systems and methods of this invention can be implemented as program embedded on personal computer such as an applet, JAVA® or CGI script, in C or C++, Fortran, or the like, as a resource residing on a server or computer workstation, as a routine embedded in a dedicated system or system component, or the like. The system can also be implemented by physically incorporating the system and/or method into a software and/or hardware system, such as the hardware and software systems of a dedicated seismic interpretation device.

It is therefore apparent that there has been provided, in accordance with the present invention, systems and methods for interpreting data. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

### REFERENCES

One of ordinary skill in the art would be aware of the following references which are incorporated herein by reference in their entirety:
1. D. Adalsteinson, J. A. Sethian, A fast level set method for propagating interfaces. Journal of Computational Physics, 269-277, 1995.
2. Apple Computer Speakable Items, http://www.apple.com/accessibility/macosx/physical.html, 2008.
3. AMD “Close to Metal” Technology Unleashes the Power of Stream Computing: AMD Press Release, Nov. 14, 2006.
4. G. Amdahl, Validity of the Single Processor Approach to Achieving Large-Scale Computing Capabilities, AFIPS Conference Proceedings, (30), pp. 483-485, 1967.
5. P. Bakker, L. J. van Vliet, and P. W. Verbeek. Edge preserving orientation adaptive filtering. Proceedings of the IEEE Conference on Computer Vision and Pattern Recognition, June, 1999.
6. P. Bakker, L. J. van Vliet, and P. W. Verbeek. Confidence and curvature of curvilinear structures in 3D. Proceedings of the Eighth IEEE International Conference on Computer Vision, Vancouver, Canada, July 2001.
7. H. Blum, A transformation for extracting new descriptors of shape, In W. Walthen-Dunn, editor, Models for the Perception of Speech and Visual Form, MIT Press, 1967.
8. H. Blum and R. N. Nagel, Shape description using weighted symmetric axis features, Pattern Recognition, nr. 10, 1978, pp. 167-180.
9. B. Blundell, A. Schwarz, Volumetric Three-Dimensional Display Systems, John Wiley & Sons, 2000.
10. M. R. Bone, B. F. Giles, E. R. Tegland, 3-D high resolution data collection, processing, and display: Houston, Tex., presented at 46^{th} Annual SEG Meeting. 1976.
11. S. Bouix and K. Siddiqi, Divergence-based Medial Surfaces, Proc. ECCV 2000, pp. 603-618, 2000.
12. E. Bradley, N. Collins and W. Kegelmeyer, Feature Characterization in Scientific Data, Proceedings of the Fourth International Symposium on Intelligent Data Analysis (IDA-01), 2001, 1-12.
13. A. Brown, Interpretation of Three-Dimensional Seismic Data, AAPG Memoir 42 SEG Investigations in Geophysics, No. 9, 1999.
14. M. Brown, W. Feng, T. Hall, M. McNitt-Gray, B. Churchill, Knowledge-based segmentation of pediatric kidneys in CT for measurement of parenchymal volume. J Comput Assist Tomogr 2001; 25:639-48.
15. A. M. Bruckstein, Analyzing and synthesizing images by evolving curves, Proc. of ICIP '94, Austin Tex., November 1994.
16. A. M. Bruckstein, G. Sapiro, and D. Shaked, Evolutions of Planar Polygons, Int. J. Pattern Recognition 9(6), 1995, 991-1014.
17. A. M. Bruckstein and D. Shaked, On Projective Invariant Smoothing and Evolutions of Planar Curves and Polygons, J. Math. Imaging Vision, 7(3), 1997, 225-240.
18. A. Buades, B. Coll, J. M. Morel, A non-local algorithm for image denoising, CVPR, 2005.
19. A. Buades, B. Coll, J. M. Morel, Image enhancement by non-local reverse heat equation, Technical report, CMLA Prepring N 2006-22, 2006.
20. I. Buck, Stream Computing on Graphics Hardware. Doctoral Thesis. UMI Order Number: AAI3162314., Stanford University, 2005.
21. J. Carlson, F. A. Dorn, Surface Draping and Surface Wrapping in CASI: User-Guided Automated Techniques for Rapid Interpretation of Structural and Stratigraphic Features, AAPG Annual Meeting, Apr. 20-23, 2008.
22. S. Chopra, Coherence cube and beyond. First Break 20, (January 2002), 27-33.
23. D. Clark, SEG's 2006 Member Compensation Survey, The Leading Edge; v. 26; no. 5; p. 578-581; May, 2007.
24. E. Cohen, R. Riesenfeld, G. Elber, Geometric Modeling with SPlines, A K Peters, 2001.
25. R. Cole, J. Mariani, H. Uszkoreit, et al., editors, Survey of the state of the art in human language technology, vol. XII-XIII, Cambridge Studies In Natural Language Processing, Cambridge University Press, ISBN 0-521-59277-1, 1997.
26. T. H. Cormen, C. E. Leiserson, R. L. Rivest, and C. Stein. Introduction to Algorithms, Second Edition. MIT Press and McGraw-Hill, 2001. ISBN 0-262-03293-7. Section 24.3: Dijkstra's algorithm, pp. 595-601.
27. N. Cornea, D. Silver, X. Yuan, and R. Balasubramanian, Computing Hierarchical Curve-Skeletons of 3D Objects, The Visual Computer, October 2005.
28. Dargay, J., D. Gately, and M. Sommer, “Vehicle ownership and income growth, Worldwide: 1960-2030”, ESRC Transport Studies Unit, University College, London, UK, January 2007.
29. C. De Graaf, A. Koster, K. Vinken, M. Viergever, A methodology for the validation of image segmentation methods. IEEE Symp Comput Based Med Syst Proc; 17-24, 1992.
30. N. A. Dodgson, “Autostereoscopic 3D Displays”. IEEE Computer 38 (8): 31-36, August, 2005.
31. J. Donnelly, Second IPTC Addresses Challenges of Project Execution, Talent Shortage, JPT, February, 2008.
32. G. Dorn. Detection and Mapping of Faults in 3-D Seismic Surveys; ARCO Oil and Gas Co., Research Report RR88-0044, September 1988 (released by ARCO management in March 2000).
33. G. A. Dorn, F. A. Coady, J. Marbach, W. S. Hammon, J. A. Carlson, B. J. Kadlec, G. Pech, A Case Study of Semi-Automatic True Volume Interpretation in CASI of Both Structure and Stratigraphy from a 3D Survey in the Gulf of Mexico, AAPG Annual Meeting, Apr. 20-23, 2008.
34. G. A. Dorn, Advanced 3-D Seismic Interpretation, pre-press, to be published jointly by the SEG and the AAPG, Tulsa, Okla., 2009.
35. Energy Information Administration, International Energy Outlook 2007, Report #: DOE/EIA-0484 (2007) Release Date: May 2007, http://www.eia.doe.gov/oiaf/ieo/highlights.html, May 2007.
36. C. Englund, Speech Recognition in the JAS 39 Gripen aircraft—adaption to speech at differeng G-loads, Master Thesis in Speech Technology, Dept of Speech, Music and Hearing, Royal Institute of Technology, Stockholm, Mar. 11, 2004.
37. Eurofighter Typhoon Direct Voice Input, http://www.eurofighter.com/et_as_vt_dv.asp, 2008.
38. C. Feddern, J. Weickert, B. Burgeth, M. Welk, Curvature-Driven PDE Methods for Matrix-Valued Images, International Journal of Computer Vision, Volume 69, Number 1, August, 2006.
39. G. Fehmers and C. Hocker. Fast structural interpretation with structure-oriented filtering. Geophysics 68, 4, July-August 2003.
40. A. F. Frangi, W. J. Niessen, K. L. Vincken, M. A. Viergever, Multiscale Vessel Enhancement Filtering, Lecture Notes in Computer Science, Issue 1496, pp. 130-137, Springer, 1998.
41. M. Gage, “Curve shortening makes convex curves circular,” Inventiones Mathematica, Vol. 76, pp. 357, 1984.
42. M. Gage and R. S. Hamilton. The heat equation shrinking convex plane curves. J. Differential Geom., 23(1):69-96, 1986.
43. M. Grayson, “The heat equation shrinks embedded plane curves to round points,” J. Diff. Geom., Vol. 26, pp. 285-314, 1987.
44. J. Gomes and O. D. Faugeras, Reconciling Distance Functions and Level Sets, Journal of Visual Communication and Image Representation, no. 11, 2000, pp. 209-223.
45. K. Gruchalla, Immersive Well-Path Editing: Investigating the Added Value of Immersion, IEEE Virtual Reality, March 27-31, Chicago, Ill., 2004.
46. http://www.GPGPU.org
47. W. S. Hammon, G. A. Dorn, B. J. Kadlec, J. Marbach, Domain Transformation in CASI: Building a Volume of Paleo-Depositional Surfaces, AAPG Annual Meeting, Apr. 20-23, 2008.
48. M. Harris, S. Sengupta, J. Owens, Parallel Prefix Sum (Scan) in CUDA, GPU Gems 3, 2007.
49. K. Hasan, P. Basser, D. Parker, A. Alexander, Analytical computation of the eigen-values and eigenvectors in dt-mri. Journal of Magnetic Resonance 152 (2001), 41-47.629-639.
50. M. S. Hassouna and A. A. Farag, Robust Centerline Extraction Framework Using Level Sets, CVPR (1) 2005: 258-465.
51. S. Henry, Understanding Seismic Amplitudes, AAPG Explorer, July and August, 2004.
52. C. Hoffmann, Geometric and Solid Modeling, Morgan Kaufmann, 1989.
53. G. Huisken. Flow by mean curvature of convex surfaces into spheres. J Differential Geom., 20(1), 1984, 237-266.
54. G. Huisken, C. Sinestrari, Mean curvature flow singularities for mean convex surfaces. Calc. Vat. Partial Differential Equations, 8, 1999, 1-14.
55. G. Huisken. Flow by mean curvature of convex surfaces into spheres. J. Differential Geom., 20(1):237-266, 1984.
56. G. Huisken, C. Sinestrari, Mean curvature flow singularities for mean convex surfaces. Calc. Vat. Partial Differential Equations, 8 (1999), 1-14.
57. D. Huttenlocher, G. Klanderman, W. Rucklidge, Comparing images using the Hausdorff distance, IEEE Trans Pattern Anal Mach Intell; 15:850-63. 1993.
58. A. Iske, T. Randen (Editors), Mathematical Methods and Modelling in Hydrocarbon Exploration and Production, Springer, 451 pages, 2005.
59. Insight Segmentation and Registration Toolkit (ITK), ITK Software Guide 2.4.0, November, 2005.
60. W. K. Jeong, R. Whitaker, and M. Dobin. Interactive 3D seismic fault detection on the Graphics Hardware. Volume Graphics, 2006.
61. W. K. Jeong, R. T. Whitaker, A Fast Iterative Method for a Class of Hamilton-Jacobi Equations on Parallel Systems, University of Utah Technical Report UUCS-07-010, Apr. 18, 2007.
62. G. Johansson, H, Can, Accelerating Marching Cubes with Graphics Hardware, Proceedings of the 2006 Conference of the Center for Advanced Studies on Collaborative Research, 2006.
63. J. C. Junqua, J. P. Haton, Robustness in Automatic Speech Recognition: Fundamentals and Applications, Kluwer Academic Publishers, ISBN 978-0792396468, 1995.
64. B. J. Kadlec, Channel Segmentation using Confidence and Curvature-Guided Level Sets on Noisy Seismic Images, IEEE Workshop on Applications of Computer Vision, January 2008.
65. B. J. Kadlec, H. M. Tufo, 3D Structure Tensor Approach to Medial-Surface Extraction and Segmentation Using Level Sets, LASTED Visualization, Imaging, and Image Processing (VIIP), Special Session on Applications of Partial Differential Equations in Geometric Design and Imaging, September 2008.
66. B. J. Kadlec, H. M. Tufo, Medial Surface Guided Level Sets for Shape Exaggeration, LASTED Visualization, Imaging, and Image Processing (VIIP), Special Session on Applications of Partial Differential Equations in Geometric Design and Imaging, September 2008.
67. B. J. Kadlec, G. A. Dorn, J. Marbach, F. A. Coady, 3D Semi-Automated Fault Interpretation in CASI Using Evolving Surfaces, AAPG Annual Meeting, Apr. 20-23, 2008.
68. B. J. Kadlec, H. M. Tufo, G. A. Dorn, D. A. Yuen, Interactive 3-D Computation of Fault Surfaces using Level Sets, Visual Geosciences, Springer, 2008.
69. B. J. Kadlec, G. A. Dorn, H. M. Tufo, Confidence and Curvature-Guided Level Sets for Channel Segmentation, SEG Annual Meeting, Nov. 12, 2008.
70. B. J. Kadlec, H. M. Tufo, D. A. Yuen, Seismic Interpretation and Visualization using Level Sets on the GPU, IEEE Visualization, 2009 (to be submitted).
71. C. M. Karat, J. Vergo, D. Nahamoo, “Conversational Interface Technologies”, in Sears, Andrew & Jacko, Julie A., The Human-Computer Interaction Handbook: Fundamentals, Evolving Technologies, and Emerging Applications (Human Factors and Ergonomics), Lawrence Erlbaum Associates Inc, ISBN 978-0805858709. 2007.
72. K. H. Karlsen, K. A. Lie, and N. H. Risebro, A fast level set method for reservoir simulation, Computational Geosciences 4(2), 185-206.
73. M. Kass, A. Witkin and D. Torsopolos, Snakes: Active Contour Models, International J. of Computer Vision, 1988, 321-331.
74. Khronos Group, The Khronos Group Releases OpenCL 1.0 Specification, December 8^{th}, 2008.
75. N. Kiryati and G. Székely, Estimating shortest paths and minimal distances on digitized three-dimensional surfaces. Pattern Recognition, 26:1623-1637, 1993.
76. R. Kimmel, D. Shaked, N. Kiryati, A. M. Bruckstein, Skeletonization via distance maps and level sets, Computer Vision and Image Understanding, v. 62 n. 3, p. 382-391, November 1995.
77. L. S. G. Kovasznay, H. M. Joseph, Image processing, Proc. IRE, 43 (1955), p. 560.
78. K. Lalonde, Investigations into the analysis of remote sensing images with a growing neural gas pattern recognition algorithm, IEEE International Joint Conference on Neural Networks, Volume 3, Issue 31, Pages 1698-1703, 2005.
79. L. J. Latecki, Q. Li, X. Bai, W. Liu. Skeletonization using SSM of the Distance Transform. IEEE Int. Conf. on Image Processing (ICIP), San Antonio, Tex., September 2007.
80. T. Lee, R. Kashyap, C. Chu, Building skeleton models via 3-D medial surface/axis thinning algorithms, CVGIP: Graphical Models and Image Processing, Volume 56, Issue 6, Pages: 462-478, 1994.
81. A. E. Lefohn, J. M. Kniss, C. D. Hansen, R. T. Whitaker, A Streaming Narrow-Band Algorithm: Interactive Computation and Visualization of Level Sets, IEEE TRANSACTIONS ON VISUALIZATION AND COMPUTER GRAPHICS, VOL. 10, NO. 4, JULY/AUGUST 2004.
82. C. Lewis, and J. Rieman, Task-centered user interface design: A practical guide, http://hcibib.org/tcuid, 1993.
83. Lorensen, W. E. and Cline, H. E., “Marching Cubes: a high resolution 3D surface reconstruction algorithm,” Computer Graphics, Vol. 21, No. 4, pp 163-169 (Proc. of SIGGRAPH), 1987.
84. R. Malladi, J. A. Sethian, and B. C. Vemuri, Shape modeling with front propagation: A level set approach. IEEE Trans. On Pattern Analysis and Machine Intelligence 17, 158-175. 1995.
85. R. Malladi, J. A. Sethian, A unified framework for Shape Segmentation, Representation and Recognition, LBL-36039, Lawrence Berkeley Laboratory, UC-Berkeley, August, 1994.
86. G. Medioni, M. Lee and C. Tang, A Computational Framework for Feature Extraction and Segmentation. Elsevier Science. March 2000.
87. Microsoft Windows Vista Speech Recognition, http://www.microsoft.com/enable/productslwindowsvista/speech.aspx, 2008.
88. J. D. Mulder, J. J. van Wijk, and R. van Liere, A survey of computational steering environments. Future Gener. Comput. Syst. 15, 1, February 1999, 119-129.
89. K. Museth, R. Whitaker, D. Breen, Editing Geometric Models, Geometric Level Set Methods in Imaging, Vision, and Graphics, Springer-Verlag, 2003.
90. U. Montanan, A Method for Obtaining Skeletons Using a Quasi-Euclidean Distance, Journal of the ACM (JACM), v. 15 n. 4, p. 600-624, October 1968.
91. J. Mulligan and G. Grudic. Topological mapping from image sequences, Proceedings of the IEEE Workshop on Learning in Computer Vision and Pattern Recognition (with CVPR05), June 2005.
92. W. W. Mullins, R. F. Sekerka, Morphological stability of a particle growing by diffusion or heat flow, J. Appl. Math, 34, 1963, 321-332.
93. C. W. Niblack, P. B. Gibbons, and D. W. Capson, Generating skeletons and centerlines from the distance transform, CVGIP: Graphical odels and Image Processing, nr. 54, 1992, pp. 420-437.
94. NVIDIA CUDA Compute Unified Device Architecture, Programming Guide, Version Beta 2.0, Apr. 2, 2008.
95. NVIDIA Tesla 51070, http://www.nvidia.com/object/product_tesla_s1070_us.html, December, 2008.
96. S. Osher, J. A. Sethian, Fronts propagating with curvature-dependent speed—Algorithms based on Hamilton-Jacobi formulations, Journal of Computational Physics, 1988.
97. S. Osher and R. Fedkiw, Level Set Methods: An Overview of Some Recent Results, Journal of Computational Physics, pages 463-502, 2001.
98. S. Osher, R. Fedkiw, Level Set Methods and Dynamic Implicit Surfaces, Springer, 2002.
99. S. Osher, N. Paragios, Geometric Level Set Methods in Imaging, Vision, and Graphics, Springer-Verlag, 2003.
100. J. Owens, D. Luebke, N. Govindaraju, M. Harris, J. Kruger, A. Lefohn, and T. Purcell, A survey of general-purpose computation on graphics hardware, Computer Graphics Forum, 26(1):80-113, March 2007.
101. K. Palagyi, A 3-subiteration 3D thinning algorithm for extracting medial surfaces, Pattern Recognition Letters 23 (2002) 663-675.
102. D. T. Paris and F. K. Hurd, Basic Electromagnetic Theory, McGraw-Hill 1969, pg. 383-385.
103. S. G. Parker, C. R. Johnson, and D. Beazley, Computational Steering Software Systems and Strategies. IEEE Comput. Sci. Eng. 4, 4 (October 1997), 50-59.
104. P. Perona, J. Malik, Scale-Space and Edge Detection Using Anisotropic Diffusion, IEEE Transactions on Pattern Analysis and Machine Intelligence, vol. 12, no. 7, pp. 629-639, July, 1990.
105. S. K. Richardsen, T. Randen, Mapping 3D Geo-Bodies Based on Level Set and Marching Methods, Mathematical Methods and Modelling in Hydrocarbon Exploration and Production, pp. 247-265, Springer, 2005.
106. RealD CrystalEyes, http://reald-corporate.com/scientific/crystaleyes.asp, 2008.
107. D. Reniers and A. Telea, 2007. Skeleton-based Hierarchical Shape Segmentation. In Proceedings of the IEEE international Conference on Shape Modeling and Applications 2007 (Jun. 13-15, 2007). SMI. IEEE Computer Society, Washington, D.C., 179-188.
108. V. Robins, J. Meiss and E. Bradley, Computing Connectedness: An Exercise in Computational Topology, Nonlinearity, 11, 1998, 913-922.
109. V. Robins, J. Meiss and E. Bradley, Computing Connectedness: Disconnectedness and discreteness, Physica, 139, 2000, 276-300.
110. V. Robins, J. Abernethy, N. Rooney and E. Bradley, Topology and intelligent data analysis, Intelligent Data Analysis, 8, 2004, 505-515.
111. V. Robins, N. Rooney and E. Bradley, Topology-Based Signal Separation, Chaos, 14, 2004, 305-316.
112. M. M Roksandic, Seismic Facies Analysis Concepts, Geophys Prospect, Volume 26 Issue 2 Page 383-398, June 1978,
113. M. Rudisill, C. Lewis, P. Polson, and T. McKay, Human-Computer Interaction: Success Cases, Emerging Methods, and Real-world Context. San Francisco: Morgan Kaufman, 1996.
114. M. Rumpf, A. Telea, A continuous skeletonization method based on level sets, Proceedings of the symposium on Data Visualisation 2002, May 27-29, 2002, Barcelona, Spain
115. P. K. Saha, B. B. Chaudhuri, Detection of 3-D simple points for topology preserving transformations with application to thinning, IEEE Transactions on Pattern Analysis and Machine Intelligence, Volume: 16, Issue: 10, pages: 1028-1032, 1994.
116. G. Sapiro, Vector (self) snakes: A geometric framework for color, texture and multiscale image segmentation. In Proc. IEEE International Conference on Image Processing, Vol. 1. Lausanne, Switzerland, 1996.
117. Y. Sato, S. Nakajima, H. Atsumi, T. Koller, G. Gerig, S. Yoshida, R. Kikinis, 3D Multi-scale line filter for segmentation and visualization of curvilinear structures in medical images, Lecture Notes in Computer Science, Issue 1205, pp. 213-222, Springer, 1997.
118. H. Scharsach, 2005. “Advanced GPU Raycasting.” In Proceedings of CESCG 2005.
119. W. Schroeder, K. Martin, B. Lorensen, The Visualization Toolkit, 3^{rd} Edition, Kitware Inc., 2004.
120. J. A. Sethian, Curvature and the Evolution of Fronts, Communication of Mathematical Physics, 101, 4, 1985.

121. J. A. Sethian, J. Strain, Crystal Growth and Dendritic Solidification, J. Comp Phys. 98, 2, pp. 231-253, 1992.
122. J. A. Sethian, A Fast Marching Level Set Method for Monotonically Advancing Fronts, Proc. Nat. Acad. Sci. vol. 93, nr. 4, pp 1591-1595, 1996.
123. J. A. Sethian, Level Set Methods and Fast Marching Methods: Evolving Interfaces in Computational Geometry, Fluid Mechanics, Computer Vision, and Materials Science, Cambridge University Press, 1999.
124. M. Showerman, J. Enos, A. Pant, QP: A Heterogeneous Multi-Accelerator Cluster, NCSA Technical Report, 2008.
125. K. Siddiqi, S. Bouix, A. Tannenbaum, S. W. Zucker, The Hamilton-Jacobi Skeleton, Proceedings of the International Conference on Computer Vision-Volume 2, p. 828, Sep. 20-25, 1999.
126. P. Soille, Morphological Image Analysis: Principles and Applications, Springer, 1999.
127. A. Steiner, R. Kimmel, A. M. Bruckstein, Planar Shape Enhancement and Exaggeration, Graphics Models and Image Processing, Volume 60, Issue 2, March 1998, Pages 112-124.
128. http://www.tatanano.com
129. N. Tatarchuk, J. Shopf, C. DeCoro, Real-Time Isosurface Extraction Using the GPU Programmable Geometry Pipeline, International Conference on Computer Graphics and Interactive Techniques, 2007.
130. H. M. Tufo, P. F. Fischer, M. E. Papka, and K. Blom, “Numerical Simulation and Immersive Visualization of Hairpin Vortex Generation”, Proceedings of SC99, 10 pages, 1999.
131. H. M. Tufo, P. F. Fischer, M. E. Papka, and M. Szymanski, “Hairpin Vortex Formation, a Case Study for Unsteady Visualization”, Proceedings of the 41st CUG Conference, 10 pages, 1999.
132. J. K. Udupa, V. R. LeBlanc, Y. Zhuge, C. Imielinska, H. Schmidt, L. M. Currie, B. E. Hirsch, J. Woodburn, A framework for evaluating image segmentation algorithms, Computerized Medical Imaging and Graphics 30, p. 75-87. 2006.
133. Visible Human Project, National Library of Medicine, National Institutes of Health, http://www.nlm.nih.gov/research/visible/visible_human.html
134. G. G. Walton, Three-dimensional seismic method: Geophysics, v. 37, p. 417-430. 1972.
135. S. Wang, A. Kaufman, Volume-Sampled 3D Modeling, IEEE Graphics and Applications, 14:26-32, 1994.
136. J. Weickert. Anisotropic diffusion in image processing. ECMI Series, Teubner, Stuttgart, 1998.
137. J. Weickert: Coherence-enhancing diffusion filtering. International Journal of Computer Vision 31: 111-127, 1999.
138. Weimer, P. & Davis, T. L. Applications of 3-D seismic data to exploration and production. AAPG Studies in Geology, 42, 270 pp, 1996.
139. C. J. Weinstein, Opportunities for Advanced Speech Processing in Military Computer-Based Systems, Lincoln Laboratory, MIT, Lexington, Mass., 19XX?.
140. R. T. Whitaker, Volumetric deformable models: Active blobs. Visualization In Biomedical Computing, SPIE, Mayo Clinic Rochester, Minn., R. A. Robb, Ed., 122-134. 1994.
141. R. T. Whitaker, A level-set approach to 3D reconstruction from range data. International Journal of Computer Vision 29, 3, 203-231, 1998.
142. Wikipedia contributors (Various Entries). Wikipedia, The Free Encyclopedia. Feb. 8, 2009.
143. B. Wyvill, A. Guy, E. Galin, Extending the CSG Tree, Warping, Blending and Boolean Operations in an Implicit Surface Modeling System, Computer Graphics Forum, 18:149-158, 1999.
144. D. A. Yuen, B. J. Kadlec, E. F. Bollig, W. Dzwinel, Z. A. Garbow, C. da Silva, Clustering and Visualization of Earthquake Data in a Grid Environment, Visual Geosciences, January, 2005.
145. A. Yuille, D. Cohen and P. Hallinan, Feature Extraction from Faces Using Deformable Templates, CVPR, 1989, 104-109.
146. J. Zhang, K. Siddiqi, D. Macrini, A. Shokoufandeh, S. Dickinson, Retrieving Articulated 3-D Models Using Medial Surfaces and Their Graph Spectra, EMMCVPR 2005, LNCS 3757, pp. 285-300, 2005.
147. H. Zhao, A fast sweeping method for Eikonal equations, Mathematics of Computation, 2004.
148. Y. Zhou, A. W. Toga, Efficient Skeletonization of Volumetric Objects, IEEE TVCG, vol. 5, no. 3, 1999, pp. 210-225.
149. L. Zhukov, K. Munseth, D. Breen, R. Whitaker, and A. H. Barr, Level set modeling and segmentation of DT-MRI brain data. 2003.

What is claimed is:

1. A computer implemented method for processing data comprising:
identifying one or more seed points in an input data volume, the input data volume including data representing a portion of an object;
utilizing an implicit surface velocity determination to identify at least one surface in the input data volume; and
one or more of outputting the at least one surface into an interactive visulation environment and storing the at least one surface in a storage device.

2. The method of claim 1, wherein the input data volume comprises seismic data.

3. The method of claim 1, wherein the input data volume includes medical imaging data.

4. The method of claim 1, wherein the input data volume includes 3-D seismic data.

5. The method of claim 1, further comprising determining derivatives and partial derivatives in the input data volume, and analyzing vector representation of magnitude changes of voxel values to determine one or more of gradients, edges, curvature, and image elements.

6. The method of claim 1, wherein level sets are used as an implicit representation of a deformable surface.

7. The method of claim 6, wherein level sets allow manipulation of the at least one surface directly.

8. The method of claim 7, wherein a level set is embedded as a zero level set of a level set function, the level set function is then evolved wherein at any time an evolving surface can be implicitly obtained by extracting the zero level set.

9. The method of claim 8, wherein a velocity of the level set is a representation that describes a motion of the surface in space and time.

10. The method of claim 1, wherein confidence and curvature information is obtained from an image structure analysis, wherein the image structure analysis uses a second order tensor to directly extract confidence and curvature information with no intermediate transformation.

11. The method of claim 1, further comprising utilizing an implicit representation of a level set to define a surface integral and a volume integral of the surface.

12. The method of claim 1, wherein a measure of confidence and curvature in input data volume will correspond to regions of high depositional curvature that present a strong and confident amplitude response.

13. The method of claim 6, wherein the level set implementation comprises data packing, numerical computation and visualization.

14. The method of claim 13, wherein data packing stores a 3-D level set function into GPU memory.

15. The method of claim 13, wherein the numerical computation of the level set optimizes data locality and maximizes compute intensity of a kernel function during each iteration.

16. The method of claim 13, wherein the visualization comprises at least one of:
a marching cubes kernel that extracts and displays an implicit surface at least one iteration; and
directly extracting and displaying an implicit surface at least one iteration.

17. The method of claim 1, further comprising iteratively developing a surface based on a voxel-by-voxel progression of the implicit surface velocity determination until a threshold is met.

18. The method of claim 17, wherein a user can steer a rendering of the surface.

19. The method of claim 1, further comprising enabling interactive steering by modifying the velocity function, wherein user-defined control of a level set surface allows growth and shrinkage of the surface.

20. The method of claim 1, further comprising determining eigenvalues and eigenvectors of a structure tensor.

21. The method of claim 20, further comprising, after determining a representation of the structure tensor and its eigenvalues and eigenvectors, determining kernels for imaging faults and channels.

22. The method of claim 21, wherein the kernels are determined during each block update of a level set domain.

23. The method of claim 22, wherein as every voxel in the level set surface is solved, further comprising determining a feature kernel and then using the resulting values in the level set determination.

24. The method of claim 1, wherein seeding is accomplished via one or more of a cubic paintbrush that can be elongated in any direction and a point set dropper that places points at mouse cursor locations.

25. The method of claim 1, further comprising allowing interactive steering by use of a shaped 3-D paintbrush.

26. The method of claim 1, further comprising providing interactive steering of an evolving surface through modification of a velocity function.

27. The method of claim 1, further comprising utilizing a Hessian matrix to enhance translation invariant second order structures in the data.

28. The method of claim 1, further comprising measuring an orientation of seismic strata using a gradient structure tensor (GST).

29. A computer-readable storage media including instructions that when executed perform the steps in claim 1.

30. One or more means for performing the steps in claim 1.

31. A system comprising:
a seed point module that identifies one or more seed points in an input data volume, the input data volume including data representing a portion of an object;
a data processing system that utilizes an implicit surface velocity determination to identify at least one surface in the input data volume; and
an output device, wherein the at least one surface is output into an interactive visulation environment that can be displayed on the output device, or stored in a storage device, the at least one surface representing a portion of the object.

32. The system of claim 31, wherein the input data volume comprises seismic data.

33. The system of claim 31, wherein the input data volume includes medical imaging data.

34. The system of claim 31, wherein the input data volume includes 3-D seismic data.

35. The system of claim 31, further comprising a structure analysis module that determines derivatives and partial derivatives in the input data volume, and analyzes a vector representation of magnitude changes of voxel values to determine one or more of gradients, edges, curvature and image elements.

36. The system of claim 31, wherein level sets are used as an implicit representation of a deformable surface.

37. The system of claim 36, wherein level sets allow manipulation of the at least one surface directly.

38. The system of claim 37, wherein a level set is embedded as a zero level set of a level set function, the level set function is then evolved wherein at any time an evolving surface can be implicitly obtained by extracting the zero level set.

39. The system of claim 38, wherein a velocity of the level set is a representation that describes a motion of the surface in space and time.

40. The system of claim 31, wherein confidence and curvature information is obtained from an image structure analysis, wherein the image structure analysis uses a second order tensor to directly extract confidence and curvature information with no intermediate transformation.

41. The system of claim 31, further comprising a level set module that uses an implicit representation of a level set to define a surface integral and a volume integral of the surface.

42. The system of claim 31, wherein a measure of confidence and curvature in input data volume will correspond to regions of high depositional curvature that present a strong and confident amplitude response.

43. The system of claim 36, wherein the level set implementation comprises data packing, numerical computation and visualization.

44. The system of claim 43, wherein data packing stores a 3-D level set function into GPU memory.

45. The system of claim 43, wherein the numerical computation of the level set optimizes data locality and maximizes compute intensity of a kernel function during each iteration.

46. The system of claim 43, wherein the visualization comprises at least one of:
a marching cubes kernel that extracts and displays an implicit surface at least one iteration; and
directly extracting and displaying an implicit surface at least one iteration.

47. The system of claim 31, wherein a surface is iteratively developed based on a voxel-by-voxel progression of the implicit surface velocity determination until a threshold is met.

48. The system of claim 47, wherein a user can steer a rendering of the surface via an input device.

49. The system of claim 31, wherein interactive steering is enabled by modifying the velocity function, wherein user-defined control of a level set surface allows growth and shrinkage of the surface.

50. The system of claim 31, further comprising a structure tensor module determines eigenvalues and eigenvectors of a structure tensor.

51. The system of claim 50, wherein, after determining a representation of the structure tensor and its eigenvalues and eigenvectors, the structure tensor module in cooperation with the channel module and fault module determines kernels for imaging faults and channels.

52. The system of claim 51, wherein the kernels are determined during each block update of a level set domain.

53. The system of claim 52, wherein as every voxel in the level set surface is solved, further comprising determining a feature kernel and then using the resulting values in the level set determination.

54. The system of claim 31, wherein seeding is accomplished via one or more of a cubic paintbrush that can be elongated in any direction and a point set dropper that places points at mouse cursor locations.

55. The system of claim 31, further comprising an input device and the interactive visulation environment that allow interactive steering by use of a shaped 3-D paintbrush.

56. The system of claim 31, wherein interactive steering of an evolving surface is provided through the use of modification of a velocity function.

57. The system of claim 31, further comprising a Hessian tensor module that utilizes a Hessian matrix to enhance translation invariant second order structures in the data.

58. The system of claim 31, wherein an orientation of seismic strata is measured using a gradient structure tensor (GST).
